(19) United States
(12) Patent Application Publication
(10) Pub. No.: US 2005/0000247 A1
(43) Pub. Date: Jan. 6, 2005

(54) Apparatus and method for producing a bent glass sheet

(76) Inventor: Hideo Yoshizawa, Osaka (JP)

Correspondence Address: IVAN L. PARSELL;420 E. SANDUSKY ST., WHARTON, OH, 43359, US

(21) Appl. No.: 10/493,291

(22) PCT Filed: Jun. 4, 2003
(86) PCT No.: PCT/JP03/07073

(30) Foreign Application Priority Data
Jun. 17, 2002 (JP) 2002-176338

(51) Int. Cl. C03B 27/044

(52) U.S. Cl. 65/104; 65/287; 65/370.1; 65/348; 65/349; 65/273; 65/106

(57) ABSTRACT

An bent glass sheet producing apparatus (20) has a heating furnace (21) in a heating zone (Z1), a preliminary forming mechanism (25) in a preliminary forming zone (Z2) downstream of the heating zone (Z1), a two-directional bending mechanism (30) and a conveyor roller mechanism (40) in a forming zone (Z3) downstream of the preliminary forming zone (Z2), and a cooling mechanism (50) in a cooling zone (Z4) downstream of the forming zone (Z3). For a purpose of conveying a two-directionally bent glass sheet formed by the two-directional bending mechanism, the conveyor roller mechanism (40) includes a plurality of conveyor rollers (41) having an arcuate shape of a radius (R2) in a direction perpendicular to the conveyance direction of the glass sheet, the conveyor rollers (41) being arranged on an arcuate line having a radius in the conveyance direction.

### TECHNICAL FIELD

This invention relates to an apparatus for producing a bent glass sheet bent in two directions, namely, a direction of its conveyance (hereinafter referred to as “conveyance direction”) and a direction perpendicular to the conveyance direction. The invention also relates to a method of producing such a bent glass sheet.

### BACKGROUND ART

There is a tendency to use as, for example, a side windowpane for a motor vehicle a glass sheet having a given radius of curvature in the direction in which it is raised and lowered, and also a given curved configuration in the longitudinal direction of the motor vehicle. Such a glass sheet is obtained by bending in two directions, namely, a conveyance direction in a producing apparatus and a direction perpendicular to the conveyance direction.

Complexly bent glass sheets obtained by bending in two directions include, among others, a glass sheet having an equal radius of curvature at any point in its longitudinal direction (conveyance direction) and also an equal radius of curvature at any point in its transverse direction perpendicular to the longitudinal direction (direction perpendicular to the conveyance direction). Such glass sheet is referred to as a “two-directionally bent glass sheet” and the following is a description of such “two-directionally bent glass sheet”.

WO0/32527 entitled “METHOD AND APPARATUS FOR PRODUCING BENT GLASS SHEET” is known as showing an apparatus for producing a bent glass sheet by bending a flat glass sheet in two directions. According to the known method and apparatus, a two-directionally bent glass sheet is produced by heating a flat glass sheet to near its softening temperature in a heating oven or furnace, while conveying it by conveyor rollers, and conveying the heated glass sheet while holding or gripping between lower rollers and an upper belt to thereby bend the heated glass sheet in two directions, namely, a conveyance direction and a direction perpendicular to the conveyance direction.

The two-directionally bent glass sheet thus produced has an arcuate shape having an equal radius of curvature at any point of the glass sheet in the conveyance direction and also a curved shape which is equally downward convex at any point in the direction perpendicular to the conveyance direction. Therefore, it can be used as a side windowpane for a motor vehicle as stated above.

Known apparatuses for producing a bent glass sheet are usually of the type in which a glass sheet heated to near a softening temperature thereof is brought into contact with the forming surface of a forming die by, for example, suction and bent along the forming surface, or of the type in which a glass sheet is bent by forming rollers. Typical examples of such known apparatuses are disclosed in Japanese Patent Laid-open Publications (JP-A) Nos. 6-127961 entitled “Apparatus and Method for Forming a Sheet Material” and 2000-327350 entitled “Method of Forming a Glass Sheet and an Apparatus Therefor”.

According to the disclosed methods and apparatuses, a forming die is disposed between a heating furnace and a cooling mechanism. A glass sheet is heated in the heating furnace and then the heated glass sheet is brought into contact with a forming surface of a forming die by, for example, suction to thereby bend the glass sheet along the forming surface and in a direction perpendicular to the conveyance direction. The thus bent glass sheet is then cooled by the cooling mechanism to set a final bent or curved configuration.

According to the techniques shown in JP-A-6-127961 and JP-A-2000-327350, it is possible to bend a glass sheet without using any belt mechanism. However, the bending direction is limited to only a direction perpendicular to the conveyance direction of the glass sheet.

In other words, the disclosed techniques can not achieve bending of a glass sheet in two directions, namely, a conveyance direction and a direction perpendicular to the conveyance direction, as in a manner shown in WO 00/32527 specified above.

Various techniques have been proposed for forming a glass sheet into a bulged shape, or forming the glass sheet complexly, but the proposed techniques have a great deal of difficulty in forming a two-directionally bent shape.

Accordingly, there has been a desire to realize an apparatus which can produce a curved glass sheet by bending a glass sheet accurately in two mutually perpendicular directions, namely, a conveyance direction and a direction perpendicular to the conveyance direction by using a forming die or forming rollers rather than by using a belt mechanism such as disclosed in WO 00/32527.

### DISCLOSURE OF THE INVENTION

It is, therefore, an object of this invention to provide an apparatus for and a method of producing a bent glass sheet which employ a forming die or forming rollers, and can form a glass sheet into an arcuate shape having an equal radius of curvature at any point of the glass sheet in a conveyance direction while forming the glass sheet into a curved shape which is equally downward convex at any point in a direction perpendicular to the conveyance direction.

To attain the above object, according to an aspect of the present invention, there is provided an apparatus for producing a bent glass sheet, comprising: a heating furnace capable of heating a glass sheet to near a softening temperature of the glass sheet; a two-directional bending mechanism for bending the heated glass sheet in two directions by bringing the heated glass sheet into contact with a forming surface of a forming die to thereby form the heated glass sheet into an arcuate shape having an equal radius of curvature at any point of the glass sheet in a direction of conveyance of the glass sheet, while forming the heated glass sheet into a curved shape which is equally downward convex in a direction perpendicular to the conveyance direction; a conveyor roller mechanism for conveying the two-directionally bent glass sheet and including a plurality of conveyor rollers having conveying surfaces complementary in shape to the downward convex curved shape of the two-directionally bent glass sheet and arranged on an arcuate line having the same radius of curvature as the arcuate shape of the two-directionally bent glass sheet; and a cooling mechanism for cooling the two-directionally bent glass sheet while the two-directionally bent glass sheet is conveyed by the conveyor roller mechanism.

By virtue of the conveyor rollers having conveying surfaces complementary in shape to the downward convex curved shape of the two-directionally bent glass sheet and arranged on an arcuate line having the same radius of curvature as the arcuate shape of the two-directionally bent glass sheet, the conveyor roller mechanism is able to provide a proper support for the whole lower surface of the two-directionally bent glass sheet. This insures reliable conveyance of the two-directionally bent glass sheet while keeping a desired bent configuration of the glass sheet.

The bent glass sheet producing apparatus may further include a preliminary forming mechanism having curved rollers for conveying the heated glass sheet from the heating furnace to the two-directional bending mechanism and allowing the heated glass sheet to bend preliminarily by sagging during conveyance by the curved rollers.

By thus allowing preliminarily bending of the heated glass sheet using the preliminary forming mechanism, a subsequent two-directional bending process can be achieved smoothly and efficiently.

Preferably, the two-directional bending mechanism is arranged to satisfy a relationship R1>R2 where R1 is the radius of the arcuate shape of the two-directionally bent glass sheet in the conveyance direction of the glass sheet, and R2 is the radius of an are defined by the curved shape of the two-directionally bent glass sheet in the direction perpendicular to the conveyance direction.

Since the radius R1 of the arcuate shape is made larger than the radius R2 of the arcuate curved shape, the degree of inclination of a conveyance surface in the conveyance direction is made relatively gentle, which enables smooth conveyance of the glass sheet.

In another aspect the invention provides an apparatus for producing a bent glass sheet, comprising: a heating furnace capable of heating a glass sheet to near a softening temperature of the glass sheet; a preliminary forming mechanism including curved rollers for allowing the heated glass sheet to bend preliminarily by sagging while the heated glass sheet is conveyed by the curved rollers; a two-directional bending mechanism for bending the preliminarily bent glass sheet in two directions by conveying the preliminarily bent glass sheet while holding the same between a plurality of lower forming rollers and a plurality of upper forming rollers to thereby form the preliminary bent glass sheet into an arcuate shape having an equal radius of curvature at any point of the glass sheet in a direction of its conveyance, while forming the preliminarily bent glass sheet into a curved shape which is downward convex in a direction perpendicular to the conveyance direction; and a cooling mechanism for cooling the two-directionally bent glass sheet.

The glass sheet, as it is conveyed in a gripped fashion by and between the upper and lower forming rollers, is bent in two directions so as to have both an arcuate shape having an equal radius of curvature at any point of the glass sheet in the direction of its conveyance and a curved shape which is downward convex in the direction perpendicular to the direction of its conveyance. During two-directional bending operation, the lower forming rollers provide a proper support for the whole lower surface of the glass sheet, and the upper forming rollers provide a proper support for the whole upper surface of the glass sheet. This insures reliable conveyance of the two-directionally bent glass sheet while keeping a desired bent configuration of the glass sheet.

Preferably, the upper forming rollers and the lower forming rollers are each have a curved shape same as the curved shape of the two-directionally bent glass sheet and arranged on an arcuate line having the same radius of curvature as the arcuate shape of the two-directionally bent glass sheet, and the two-directional bending mechanism is arranged to satisfy a relationship R1>R2 where R1 is the radius of the arcuate line on which the upper and lower forming rollers are arranged in the conveyance direction of the glass sheet, and R2 is the radius of an are defined by the curved shape of the upper and lower forming rollers in the direction perpendicular to the conveyance direction.

Since the arcuate shape of the upper and lower forming rollers is made to have a larger radium R1 than the arcuate line of arrangement of the upper and rower forming rollers, it is possible to provide a conveyance surface having a relatively gentle slope or inclination in the conveyance direction. This enables smooth conveyance of the glass sheet.

The cooling mechanism may include a plurality of pairs of upper and lower cooling conveyor rollers for holding the two-directionally bent glass sheet therebetween. The upper cooling conveyor rollers and the lower cooling conveyor rollers have a curved shape same as the curved shape of the two-directionally bent glass sheet in the conveyance direction of the glass sheet. The upper and lower cooling conveyor rollers each arranged on an arcuate line extending along the conveyance direction of the glass sheet, the arcuate line having the same radius of curvature as the arcuate shape of the two-directionally bent glass sheet in the conveyance direction.

Since the upper and lower cooling conveyor rollers each have the curved shape and arranged on the arcuate line as specified above, the lower cooling conveyor rollers provide a proper support for the entire area of a lower surface of the two-directionally bent glass sheet, and the upper cooling conveyor rollers provide a proper support for the entire area of an upper surface of the two-directionally bent glass sheet.

This makes it possible to cool down the two-directionally bent glass sheet while maintaining a desired bent shape or configuration, thus ensuring production of a desired two-directionally bent glass sheet.

Preferably, the apparatus further includes upper and lower cooling nozzle boxes for blowing air against the two-directionally bent glass sheet to forcibly cool or quench the latter while the two-directionally bent glass sheet is conveyed by the upper and lower cooling conveyor rollers.

By thus forcibly cooling or quenching the two-directionally bent glass sheet with air blown thereagainst, it is possible to modify the two-directionally bent glass sheet into, for example, a tempered glass sheet.

In still another aspect the invention provides a method of producing a bent glass sheet, comprising the steps of: heating a glass sheet to near its softening temperature in a heating furnace; bending the heated glass sheet in two directions by bringing the heated glass sheet into contact with a forming surface of a forming die to thereby form the heated glass sheet into an arcuate shape having an equal radius of curvature at any point of the glass sheet in a direction of its conveyance, while forming the heated glass sheet into a curved shape which is downward convex in a direction perpendicular to the conveyance direction; conveying the two-directionally bent glass sheet to a cooling mechanism while carrying the two-directionally bent glass sheet on conveyor rollers having conveying surfaces complementary in shape to the convex curved shape of the two-directionally bent glass sheet and arranged on an arcuate line having the same radius of curvature as the arcuate shape of the two-directionally bent glass sheet; and quenching the two-directionally bent glass sheet by the cooling mechanism.

A glass sheet is bent in two directions as it is brought into contact with the forming surface of the forming die. The two-directionally bent glass sheet is carried on the conveyor rollers each having the conveying surface complementary in shape to the curved shape of the two-directionally bent glass sheet. The two-directionally bent glass sheet is then conveyed by the conveyor rollers that are arranged on the arcuate line having the same radius of curvature as the arcuate shape of the two-directionally bent glass sheet.

Since the entire area of a lower surface of the two-directionally bent glass sheet is properly supported by the conveyor rollers, conveyance of the two-directionally bent glass sheet can be conducted stably while maintaining a desired curved configuration of the glass sheet.

It is preferable that the foregoing method further comprises, between the heating and the bending, preliminarily bending the heated glass sheet by conveying the heated glass sheet by curved rollers and allowing the heated glass sheet to bend by sagging during conveyance by the curved rollers.

By thus allowing preliminarily bending of the glass sheet, a subsequent bending process provided for bending the preliminarily bent glass sheet into a desired curved configuration can be achieved efficiently.

Preferably, the heated glass sheet is brought into contact with the forming surface of the forming die in such a manner as to satisfy a relationship R1>R2 where R1 is the radius of the arcuate shape of the two-directionally bent glass sheet in the conveyance direction of the glass sheet, and R2 is the radius of an are defined by the curved shape of the two-directionally bent glass sheet in the direction perpendicular to the conveyance direction.

Since the radius R1 of the arcuate shape is made larger than the radius R2 of the arcuate curved shape, the degree of inclination of a conveyance surface in the conveyance direction is made relatively gentle. This enables smooth conveyance of the glass sheet.

In a further aspect the invention provides a method of producing a bent glass sheet, comprising: heating a glass sheet to near its softening temperature in a heating furnace conveying the heated glass sheet by curved rollers and allowing the heated glass to bend preliminarily by sagging during conveyance by the curved rollers; bending the preliminarily bent glass sheet in two directions by conveying the preliminarily bent glass sheet to a cooling mechanism while supporting the preliminary bent glass sheet between a plurality of upper forming rollers and a plurality of lower forming rollers so as to form the preliminarily bent glass sheet into an arcuate shape having an equal radius of curvature at any point of the glass sheet in the direction of its conveyance, while forming thee preliminarily bent glass sheet into a curved shape which is downward convex in a direction perpendicular to the conveyance direction; and quenching the two-directionally bent glass sheet by the cooling mechanism.

The glass sheet, as it is conveyed while being supported by and between the upper and lower forming rollers of the conveyor roller mechanism, is bent into two direction such that the glass sheet is formed to have an arcuate shape having an equal radius of curvature at any point of the glass sheet in the conveyance direction and also have a curved shape which is downward convex in a direction perpendicular to the conveyance direction

During the bending process, the lower forming rollers provide a proper support for the entire area of a lower surface of the glass sheet, and the upper forming rollers provide a proper support for the entire area of an upper surface of the glass sheet. This ensures reliable conveyance of the two-directionally bent glass sheet while maintaining a given bent configuration of the glass sheet.

Preferably, the preliminarily bent glass sheet, as it is conveyed while being supported between the upper and lower forming rollers, is gradually bent in said two directions in such a manner as to satisfy a relationship R1>R2 where R1 is the radius of the arcuate shape of the two-directionally bent glass sheet in the conveyance direction of the glass sheet, and R2 is the radius of an are defined by the curved shape of the two-directionally bent glass sheet in the direction perpendicular to the conveyance direction.

Because the radius R1 of the arcuate shape is made larger than the radius R2 of the arcuate curved shape, the degree of inclination of a conveyance surface in the conveyance direction is made relatively gentle. This enables smooth conveyance of the glass sheet.

Preferably, while the two-dimensionally bent glass sheet is quenched by the cooling mechanism, the two-directionally bent glass sheet is conveyed while being supported by and between upper cooling conveyor rollers and lower cooling conveyor rollers. The upper and lower cooling conveyor rollers have a curved shape same as the curved shape of the two-directionally bent glass sheet in the direction perpendicular to the conveyance direction of the glass sheet. The upper and lower cooling conveyor rollers are each arranged on an arcuate line extending along the conveyance direction of the glass sheet, the arcuate line having the same radius of curvature as the arcuate shape of the two-directionally bent glass sheet.

Since a lower surface of the two-directionally bent glass sheet is properly supported in its entire area by the lower cooling conveyor rollers and, at the same time, an upper surface of the same glass sheet is properly supported at its entire area by the upper cooling conveyor rollers, the two-directionally bent glass sheet is conveyed while maintaining its given bent or curved configuration. This ensures production of a two-directionally bent glass sheet having a desired bent configuration.

It is preferable that the quenching is carried out by blowing air against both upper and lower surfaces of the two-directionally bent glass sheet while the two-directionally bent glass sheet is conveyed in a supported fashion by and between the upper and lower cooling conveyor rollers.

By thus quenching the two-directionally bent glass sheet with air blown thereagainst, it is possible to modify the two-directionally bent glass sheet into, for example, a tempered glass sheet.

### BRIEF DESCRIPTION OF THE DRAWINGS

Certain preferred embodiments of the present invention will be described in detail below, by way of example only, with reference to the accompanying drawings, in which:

FIG. 1 is a perspective view of a two-directionally bent-glass sheet as produced by an apparatus for producing a bent glass sheet according to a first embodiment of the present invention;

FIG. 2 is a diagrammatical side elevational view of the apparatus for producing a bent glass sheet according to the first embodiment of the invention;

FIG. 3(a) is a cross-sectional view take along line 3a-3a of FIG. 2;

FIG. 3(b) is a cross-sectional view taken along line 3b-3b of FIG. 2;

FIG. 4 is a perspective view, with parts cut away for clarity, of the bent glass sheet producing apparatus according to the first embodiment of the invention;

FIG. 5 is a simplified perspective view showing a conveyor roller mechanism of the bent glass sheet producing apparatus according to the first embodiment of the invention;

FIG. 6 is a simplified perspective view showing a cooling mechanism of the bent glass sheet producing apparatus according to the first embodiment of the invention;

FIGS. 7(a) and 7(b) are diagrammatical views illustrating a first stage of operation of the bent glass sheet producing apparatus according to the first embodiment of the invention;

FIGS. 8(a) and 8(b) are diagrammatical views illustrating a second stage of operation of the bent glass sheet producing apparatus according to the first embodiment of the invention;

FIG. 9 is a diagrammatical view illustrating a third stage of operation of the bent glass sheet producing apparatus according to the first embodiment of the invention;

FIG. 10 is a diagrammatical side elevational view of an apparatus for producing a bent glass sheet according to a second embodiment of the present invention;

FIG. 11 is a perspective view, with parts cut away for clarity, of the bent glass sheet producing apparatus according to the second embodiment of the invention;

FIGS. 12(a) and 12(b) are diagrammatical views illustrating a first stage of operation of the bent glass sheet producing apparatus according to the second embodiment of the invention;

FIGS. 13(a) and 13(b) are diagrammatical views illustrating a second stage of operation of the bent glass sheet producing apparatus according to the second embodiment of the invention;

FIG. 14 is a diagrammatical view illustrating a third stage of operation of the bent glass sheet producing apparatus according to the second embodiment of the invention;

FIG. 15 is a diagrammatical side elevational view of an apparatus for producing a bent glass sheet according to a third embodiment of the present invention;

FIG. 16 is a perspective view, with parts cut away for clarity, of the bent glass sheet producing apparatus according to the third embodiment of the invention;

FIG. 17 is a perspective view, with parts cut away for clarity, of a two-directional bending mechanism of the bent glass sheet producing apparatus according to the third embodiment of the invention;

FIGS. 18(a) and 18(b) are diagrammatical views illustrating a first stage of operation of the bent glass sheet producing apparatus according to the third embodiment of the invention; and

FIGS. 19(a) and 19(b) are diagrammatical views illustrating a second stage of operation of the bent glass sheet producing apparatus according to the third embodiment of this invention.

### BEST MODE FOR CARRYING OUT THE INVENTION

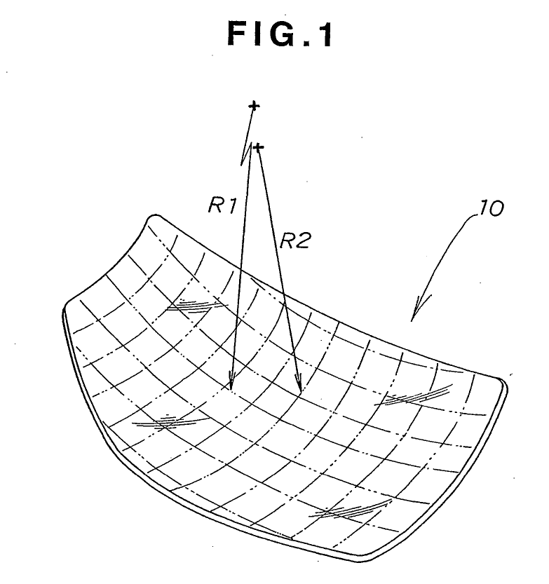

FIG. 1 shows in perspective a typical example of two-directionally bent glass sheets produced by a bent glass sheet producing apparatus according to a first embodiment of the present invention.

The two-directionally bent glass sheet 10 has an equal radius R1 of curvature at any point thereof in its longitudinal direction as viewed in the drawing (direction of conveyance) and an equal radius R2 of curvature at any point thereof in its transverse direction perpendicular to the longitudinal direction as viewed in the drawing (direction perpendicular to the conveyance direction).

The two-directionally bent glass sheet 10 is applicable to, for example, a side windowpane (not shown) of a motor vehicle, which can be raised and lowered.

The following is a description of the producing apparatus and process for producing the two-directionally bent glass sheet 10.

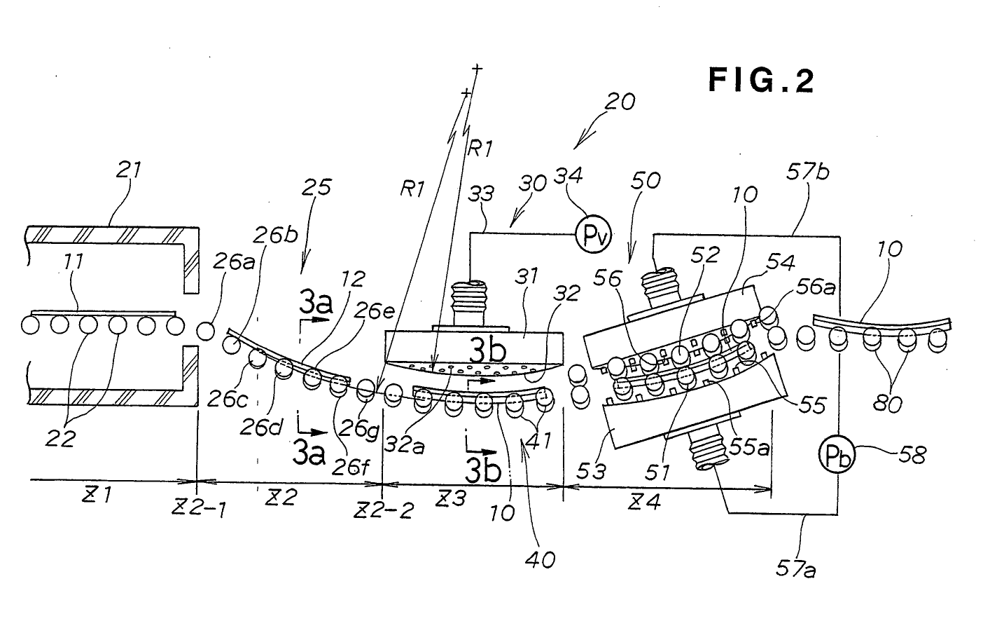

Reference is now made to FIG. 2 showing in side elevation a bent glass sheet producing apparatus according to the first embodiment of the present invention.

The apparatus 20 comprises a heating oven or furnace 21 disposed in a heating zone Z1, a preliminary forming mechanism 25 disposed in a preliminary forming zone Z2 downstream of the heating zone Z1, a two-directional bending mechanism 30 and a conveyor roller mechanism 40 both disposed in a forming zone Z3 downstream of the preliminary forming zone Z2, and a cooling mechanism 50 disposed in a cooling zone Z4 downstream of the forming zone Z3.

The heating furnace 21 has a series of horizontally arranged conveyor rollers 22 for conveying a glass sheet 11 in the furnace 21 horizontally and is designed for heating the glass sheet 11 to near its softening temperature.

The preliminary forming mechanism 25 has a plurality of preliminary forming rollers, or first to seventh preliminary forming rollers 26a to 26g shown in the drawing, and arranged at specific intervals (of, for example, 50 to 100 mm) on an are having a radius R1. These rollers 26a to 26g are axially curved to different degrees that become gradually greater from one roller to another in a direction from the upstream side to the downstream side of the preliminary forming zone Z2.

More specifically, the first preliminary forming roller 26a forming an upstream end roller of the first to seventh preliminary forming rollers 26a-26g is a straight roller, and the seventh preliminary forming roller 26g forming a downstream end roller is an arcuate roller having a radius R2. The second to sixth preliminary forming rollers 26b to 26f disposed between the first preliminary forming roller 26a and the seventh preliminary forming roller 26g have respective axial curvatures that become gradually greater in a direction from the upstream side to the downstream side.

The first to seventh preliminary forming rollers 26a to 26g are each composed of a roller shaft and a cylindrical sleeve fitted around the roller shaft and connected to a rotating drive unit (not shown). Thus, the sleeve fitted around the roller shaft is rotatable by the rotating drive unit. The roller shafts and sleeves of the second to seventh preliminary forming rollers 26b-26g are curved.

The sleeve is a member having an outer periphery covered with a heat resistant material and adapted to contact a glass sheet 11.

The first to seventh preliminary forming rollers 26a to 26g convey the glass sheet 11 heated to near a softening temperature thereof and thus allow the heated glass sheet 11 to sag down by its own weight, thereby yielding a glass sheet 12 bent preliminarily in two directions, i.e. a direction of its conveyance and a direction perpendicular to the conveyance direction.

The two-directional bending mechanism 30 is constructed such that the glass sheet 12 formed preliminarily in two directions by the preliminary forming mechanism 25 is brought by suction into intimate contact with a forming surface 32 of a forming die 31 so that the preliminarily bent glass sheet is further bent in two directions to have a final bent shape having an equal radius R1 of curvature at any point thereof in the conveyance direction and also a curved shape which is equally downward convex at any point thereof in the direction perpendicular to the conveyance direction.

The downwardly convex curved shape will be taken as an are having a radius R2 by way of example in the description of the present embodiment.

The conveyor roller mechanism 40 has a plurality of conveyor rollers 41 formed in a downward convex curved shape as viewed in a direction perpendicular to the conveyance direction of the glass sheet and arranged at predetermined intervals (of, for example, 50 to 100 mm) on an are having a radius R1 as viewed in the direction of conveyance, in order to convey the two-directionally bent glass sheet 10 formed by the two-directional bending mechanism 30.

The convex curved shape will be taken as an are having a radius R2 by way of example in the description of the present embodiment.

The cooling mechanism 50 is provided for cooling the two-directionally bent glass sheet 10 fed from the conveyor roller mechanism 40. The cooling mechanism 50 is followed downstream by conveyor rollers 80 for conveying the two-directionally bent glass sheet 10 after it is cooled by the cooling mechanism 50.

The bent glass sheet producing apparatus 20, as a whole, has a glass sheet conveyance path formed in an arcuate shape curved in the direction of conveyance and having a radius R1 in order to bend the glass sheet into an arcuate shape having an equal radius R1 of curvature at any point in the direction of its conveyance.

It is, therefore, likely that if, for example, the conveyance path has a greater level of height at the exit of the cooling mechanism 50 than at the exit of the heating furnace 21 and thereby forms an upward slope as a whole, its inclination may be so sharp, depending on the value of radius R1, as to cause the glass sheet to slip.

It is also likely that if the conveyance path has a smaller level of height at the exit of the cooling mechanism 50 than at the exit of the heating furnace 21 and thereby forms a downward slope as a whole, its inclination may be so sharp as in the case of the upward slope, depending on the value of radius R1, as to cause the glass sheet to slip.

In order to avoid slipping of the glass sheet, therefore, it is desirable for the conveyance path to have substantially the same height at the exit of the heating furnace 21 and at the exit of the cooling mechanism 50. Then, the conveyance path forms a downward slope up to its middle point and is followed thereafter by an upward slope, so that each slope may have a reduced inclination, thereby making it possible to avoid any slipping of the glass sheet.

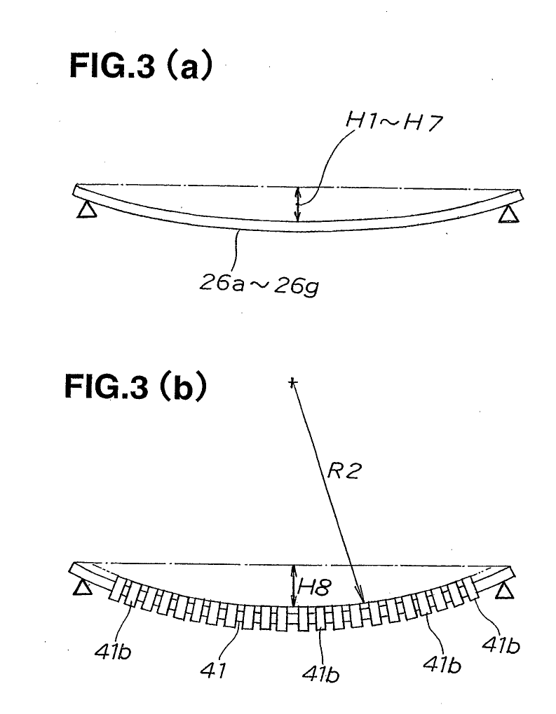

FIG. 3(a) is a sectional view taken along line 3a-3a of FIG. 2, and FIG. 3(b) is a sectional view taken along line 3b-3b of FIG. 2.

In FIG. 3(a), reference characters H1-H7 denote heights of the first to seventh preliminary forming rollers 26a to 26g, respectively, as measured from the top to the center of the respective preliminary forming rollers 26a-26g that are arranged in the preliminary forming zone Z2 shown in FIG. 2 in the order as viewed from the entrance Z2-1 to the exit Z2-2 of the zone Z2.

More specifically, the first preliminary forming roller 26a has a height H1, the second preliminary forming roller 26b has a height H2, the third preliminary forming roller 26c has a height H3, the fourth preliminary forming roller 26d has a height H4, the fifth preliminary forming roller 26e has a height H5, the sixth preliminary forming roller 26f has a height H6 and the seventh preliminary forming roller has a height H7. The heights H1 to H7 have a relationship expressed as H1<H2<H3<H4<H5<H6<H7.

As shown in FIG. 3(b), each conveyor roller 41 has a height H8 as measured from the top to the center of the conveyor roller 41. The height H8 is equal to, or slightly larger than, the height H7 of the seventh preliminary forming roller 26g. Thus, each conveyor roller 41 has a downward convex curved shape.

The convex curved shape of the conveyor rollers 41 is an are having a radius R2, as stated before. The radius R2 is preferably smaller than the radius R1 shown in FIG. 2, as is expressed as R1>R2.

By virtue of a combination of the downward convex curved shape as viewed in the direction perpendicular to the conveyance direction and the arcuate arrangement as viewed in the conveyance direction, the conveyor rollers 41 of the conveyor roller mechanism 40 can provide a good support for the entire area of a lower surface of the two-directionally bent glass sheet 10.

Accordingly, it is possible to secure reliable conveyance of the two-directionally bent glass sheet 10, while maintaining a desired curved shape or configuration. This enables accurate production of a two-directionally bent glass sheet 10.

Each conveyor roller 41 carries ring rollers (large-diameter rollers) 41b arranged at regular intervals with relatively high density. In the figures described below, however, the large-diameter rollers (ring rollers) 41b are shown coarsely for the convenience of easier understanding of the drawing.

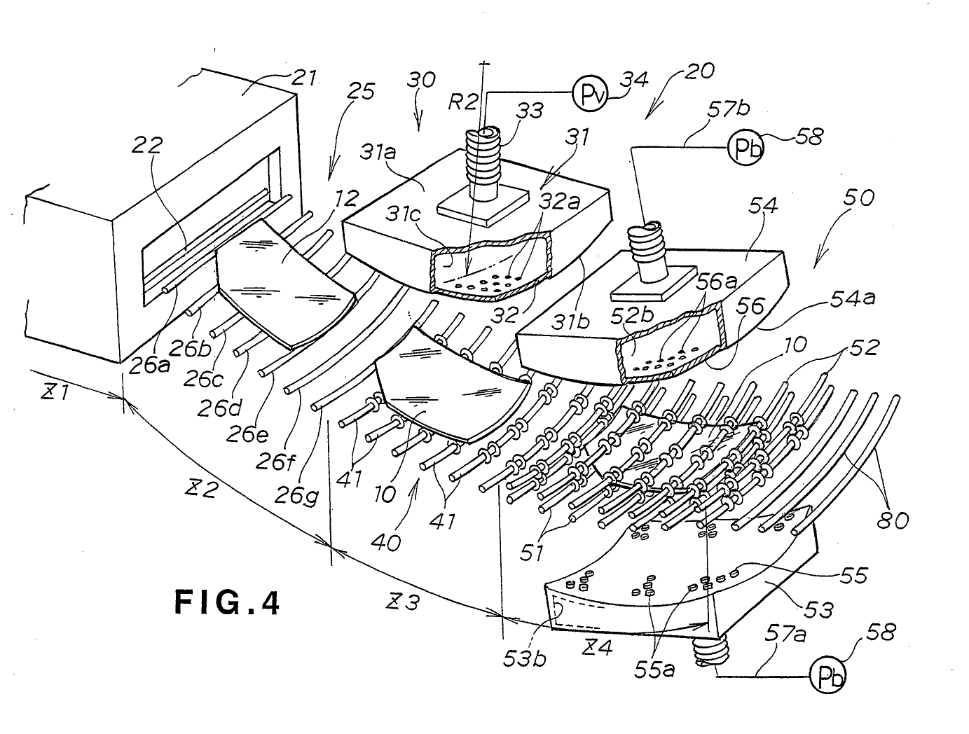

FIG. 4 is a perspective view of the bent glass sheet producing apparatus 20 according to the first embodiment.

The two-directional bending mechanism 30 has a hollow forming die 31 having a top 31a to which a vacuum pump 34 is connected by a suction passage 33.

The forming die 31 has a forming surface 32 at its bottom 31b. The forming surface 32 forms a two-directional bending surface having an arcuate shape with an equal curvature (of radius R1) at any point in the conveyance direction and an arcuate shape with an equal radius R2 at any point in a direction perpendicular to the conveyance direction. The forming surface 32 has a plurality of suction holes 32a (see FIG. 2, too).

The plural suction holes 32a can be connected with the vacuum pump 34 through a hollow interior portion 31c of the forming die 31 and the suction passage 33. Thus, the glass sheet 12 conveyed to below the forming die 31 can be brought into intimate contact with the forming surface 32 by suction when the vacuum pump 34 is driven to draw air into the hollow interior portion 31c of the forming die 31 through the plural suction holes 32a.

As a result of intimate contact with the forming surface 32 under suction, the glass sheet 12 is bent into an arcuate shape having an equal radius R1 of curvature at any point of the glass sheet 12 in the conveyance direction and also an arcuate shape having an equal radius R2 at any point of the glass sheet 12 in the direction perpendicular to the conveyance direction.

Thus, the preliminarily bent glass sheet 12 is bent bi-directionally into a two-directionally bent glass sheet 10.

The conveyor roller mechanism 40 has a plurality of conveyor rollers 41 arranged at predetermined intervals on an are having a radius R1 (see FIG. 2) and each forming an are having a radius R2 (see FIG. 3(b), too). According to the present embodiment, radius R1 is larger than radius R2. As R1>R2, the conveyor roller mechanism 40 defines a mildly curved are in the direction of conveyance and can smoothly convey the two-directionally bent glass sheet 10 formed by the two-directional bending mechanism 30.

Radius R1 is, for example, from 15,000 to 50,000 mm, but is not so limited, but similar results can be obtained even if it may exceed 50,000 (though not including ∞).

Radius R2 is, for example, from 1,000 to 3,000 mm, but is not so limited.

The cooling mechanism 50 is typically shown by a quench mechanism for strengthening or tempering a glass sheet, and has a plurality of lower quench conveyor rollers (lower cooling conveyor rollers) 51, a plurality of upper quench conveyor rollers (upper cooling conveyor rollers) 52, a lower cooling nozzle box 53 on the side of the lower quench conveyor rollers 51, and an upper cooling nozzle box 54 on the side of the upper quench conveyor rollers 52.

The upper and lower quench conveyor rollers 52 and 51 are adapted to hold the two-directionally bent glass sheet 10 therebetween.

The upper and lower quench conveyor rollers 52 and 51 are arcuate with a radius R2 (the same with the conveyor roller 41 shown in FIG. 3(b)) and are arranged at predetermined intervals (of, for example, 50 to 100 mm) on an are having a radius R1 (see FIG. 2).

Thus, the lower quench conveyor rollers 51 provide a good support for the entire area of a lower surface of the two-directionally bent glass sheet 10 and the upper quench conveyor rollers 52 provide a good support for the entire area of an upper surface of the two-directionally bent glass sheet 10.

It is, therefore, possible to cool the two-directionally bent glass sheet 10, while maintaining a curved shape as desired. This ensures production of a two-directionally bent glass sheet 10 with high accuracy.

The lower cooling nozzle box 53 has, as a typical example, an air jetting surface 55 at its top and the air jetting surface 55 is a concavely curved surface. More specifically, the lower cooling nozzle box 53 has a plurality of air nozzles 55a formed in an upper surface thereof facing the lower quench conveyor rollers 51, and the air jetting surface 55 is defined by the fore ends of the plural air nozzles 55a. The air jetting surface 55 is spaced a distance from the glass sheet so as not to contact with the glass sheet.

Similarly, the upper cooling nozzle box 54 has, as a typical example, an air jetting surface 56 at its bottom and the air jetting surface 56 is a convexly curved surface. More specifically, the upper cooling nozzle box 54 has a plurality of air nozzles 56a formed in a lower surface thereof facing the upper quench conveyor rollers 52, and the air jetting surface 56 is defined by the fore ends of the plural air nozzles 56a. The air jetting surface 56 is spaced a distance from the glass sheet so as not to contact with the glass sheet.

An air supply pump 58 is connected to the lower cooling nozzle box 53 by an air supply passage 57a. This makes it possible to connect the plural nozzles 55a with the air supply pump 58 through the hollow portion 53b of the lower cooling nozzle box 53 and the air supply passage 57a. Likewise, the air supply pump 58 is connected to the upper cooling nozzle box 54 by an air supply passage 57b. This makes it possible to connect the plural nozzles 56a with the air supply pump 58 through the hollow portion 52b of the upper cooling nozzle box 52 and the air supply passage 57b.

Thus, the air supply pump 58 can be driven to jet out air from the upper and lower nozzles 55a and 56a against opposite surfaces of the two-directionally bent glass sheet 10 for forcibly cooling or quenching the glass sheet.

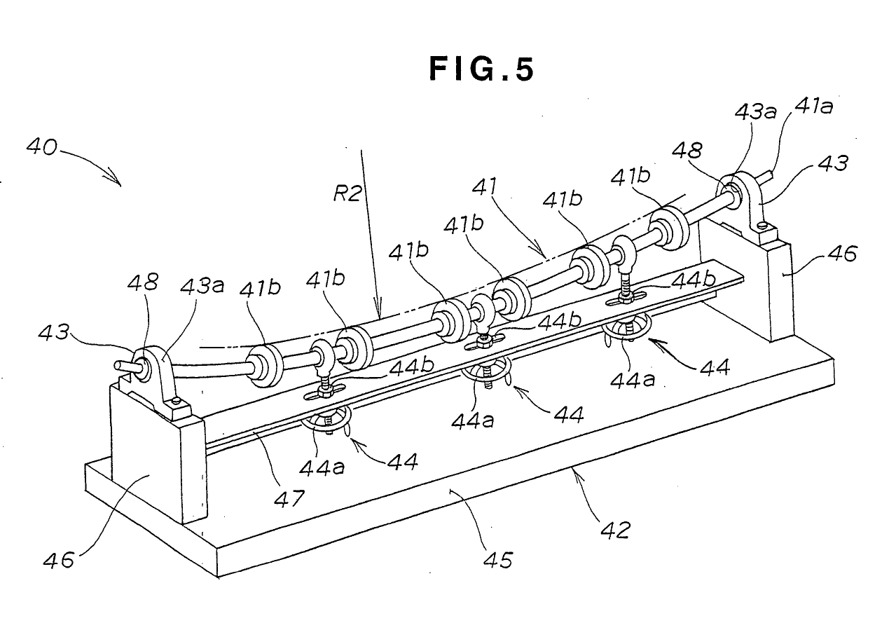

FIG. 5 is a simplified perspective view showing the conveyor roller mechanism in the bent glass sheet producing apparatus according to the first embodiment.

The conveyor roller mechanism 40 has a base 42, lift and right support members 43, 43 between which one conveyor roller 41 is rotatably and pivotally supported, and a plurality of curve-and-support members 44 for curving the conveyor roller 41.

The base 42 is composed of a base table 45, right and left support blocks 46 attached to left and right ends of the base table 45, and a cross member 47 extending between the support blocks 46. The support members 43 are each attached to a respective one of the support blocks 46, 46 and have a bush 48 rotatably and pivotally received in a mounting hole 43a of the support member 43.

Each conveyor roller 41 is composed of a rod 41a formed from an elastic member and large-diameter rollers 41b rotatably mounted on the rod 41a. Left and right ends of the conveyor roller 41 are attached via the bushes 48, 48 to the support members 43. Predetermined portions of the conveyor roller 41 are supported by the curve-and-support members 44 in a manner that the conveyor roller 41 is curved or bent to assume an arcuate shape having a radius R2.

The conveyor roller 41 carries the ring rollers (large-diameter rollers) 41b at regular intervals with relatively high density as described above with reference to FIG. 3(b). The large-diameter rollers 41b are, however, shown coarsely for the convenience of easier understanding of the drawing.

Each curve-and-support member 44 is provided to curve or bend the conveyor roller 41 into, for example, an arcuate shape of radius R2 by adjusting a handle 44a and a nut 44b.

The are of radius R2 of the conveyor roller 41 can be altered into any curved shape as desired by adjusting the handle 44a and the nut 44b of each cure-and-support member 44. By thus changing the curved shape of the conveyor roller 41, it becomes possible to alter the curvature of the two-directionally bent glass into any curved shape as desired, other than the are of radius R2.

The construction of the conveyor roller 41 as described with reference to FIG. 5 is not limitative, but it can also be so constructed, for example, that the rod 41a is stationary while the large-diameter rollers 41b are rotatable and driven in rotation by a rotating drive unit (not shown).

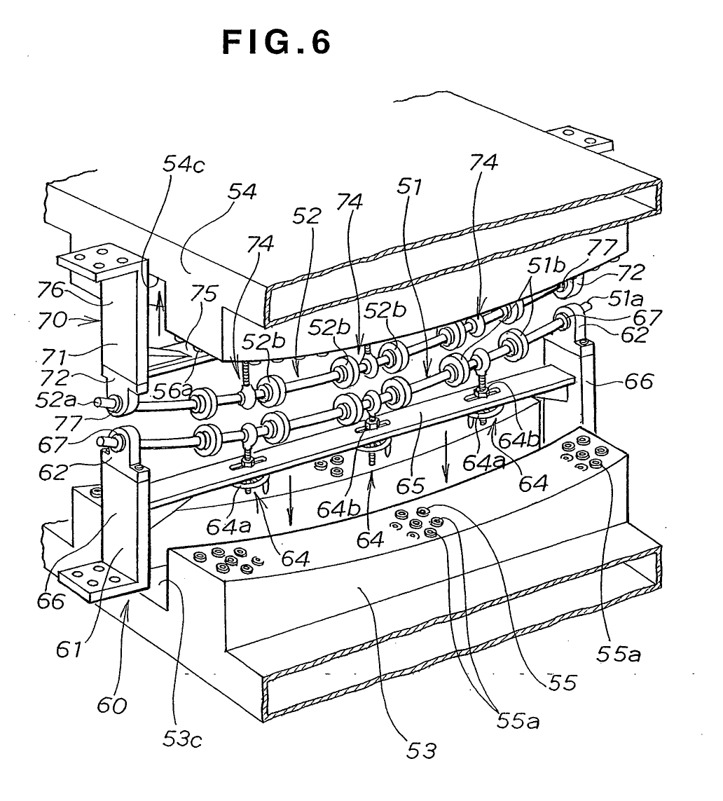

FIG. 6 is a simplified perspective view of the cooling mechanism of the bent glass sheet producing apparatus according to the first embodiment, the view showing on enlarged space a typical example of the upper and lower quench conveyor rollers 52, 51 and the upper and lower cooling nozzle boxes 54, 53 jointly forming the cooling mechanism 50.

The lower quench conveyor roller 51 is rotatably supported by a tilt support unit 60. The tilt support unit 60 is essentially received in a recessed portion 53c of the lower cooling nozzle box 53, so that the lower quench conveyor roller 51 can be installed along a transverse portion of the air jetting surface 55 of the lower cooling nozzle box 53, as shown in FIG. 2. This enables uniform cooling of the glass sheet 10 (see FIG. 2).

The tilt support unit 60 has left and right support members 62 formed at the left and right ends, respectively, of a base 61. The lower quench conveyor roller 51 has opposite end portions rotatably supported in an inclined condition by the support members 62. The base 61 includes a plurality of curve-and-support members 64 for supporting given intermediate portions of the lower quench conveyor roller 51.

The base 61 is composed of left and right L-shaped support blocks 66, 66 and a cross member 65 connected at opposite end to the support blocks 66, 66. The support-members 62 are mounted on the support-blocks 66, 66.

The left support member 62 has a bush 67 by means of which the left end portion of the lower quench conveyor roller 51 can be rotatably supported in an inclined form. Similarly, the right support member 62 has a bush 67 through which the right end portion of the lower quench conveyor roller 51 is rotatably supported in an inclined form.

Each curve-and-support member 64 is provided to curve or bend the lower quench conveyor roller 51 into, for example, an arcuate shape of radius R2. By properly adjusting a handle 64a and a nut 64b, the curve-and-support member 64 can alter or change the curvature of the lower quench conveyor roller 51 into any curved shape as desired other than the are of radius R2.

Each lower quench conveyor roller 51 is composed of a rod 51a formed from an elastic member and large-diameter rollers 51b rotatably mounted on the elastic rod 51a.

The lower quench conveyor roller 51 carries thereon the large-diameter rollers 51b at regular intervals with relatively high density. The large-diameter rollers 51b are, however, shown coarsely for the convenience of easier understanding of the drawing.

The recessed portion 53c of the lower cooling nozzle box 53 receives therein a main part of the support unit 60, and the air jetting surface 55 is formed by respective fore ends of the nozzles 55a of the lower cooling nozzle box 53.

When the air supply pump 58 shown in FIGS. 2 and 4 is driven, pressurized air is ejected from the nozzles 55a that forming the air jetting surface 55.

The upper quench conveyor roller 52 is rotatably supported by a tilt support unit 70. The tilt support unit 70 is essentially received in a recessed portion 54c of the upper cooling nozzle box 4, so that the upper quench conveyor roller 52 can be installed along a transverse portion of the air jetting surface 56 of the upper cooling nozzle box 54, as shown in FIG. 2.

The tilt support unit 70 has left and right support members 72 formed at the left and right ends, respectively, of a base 71. The upper quench conveyor roller 52 has opposite end portions rotatably supported in an inclined condition by the support members 72. The base 71 includes a plurality of curve-and-support members 74 for supporting given intermediate portions of the upper quench conveyor roller 52.

The base 71 is composed of left and right L-shaped support blocks 76, 76 and a cross member 75 connected at opposite end to the support blocks 76, 76. The support members 72 are mounted on the support blocks 76.

The left support member 72 has a bush 77 by means of which the left end portion of the upper quench conveyor roller 52 can be rotatably supported in an inclined form. Similarly, the right support member 72 has a bush 77 through which the right end portion of the upper quench conveyor roller 52 is rotatably supported in an inclined form.

Each curve-and-support member 74 is provided to curve or bend the upper quench conveyor roller 52 into, for example, an arcuate shape of radius R2. By properly adjusting a handle and a nut (neither shown) in the same manner as those 64a, 64b of the curve-and-support member 64, the curve-and-support member 74 can alter or change the curvature of the upper quench conveyor roller 52 into any curved shape as desired other than the are of radius R2.

Each upper quench conveyor roller 52 is composed of a rod 52a formed from an elastic member and large-diameter rollers 52b rotatably mounted on the elastic rod 52a.

The upper-quench conveyor-roller 52 carries thereon the large-diameter rollers 52b at regular intervals with relatively high density, as in the same manner as the lower quench conveyor roller 51. The large-diameter rollers 52b are, however, shown coarsely for the convenience of easier understanding of the drawing.

The recessed portion 54c of the lower cooling nozzle box 54 receives therein a main part of the support unit 70, and the air jetting surface 56 is formed by respective fore ends of the nozzles 56a (FIG. 4) of the lower cooling nozzle box 54.

When the air supply pump 58 shown in FIGS. 2 and 4 is driven, pressurized air is ejected from the nozzles 56a that forming the air jetting surface 56.

According to the cooling mechanism 50, the lower quench conveyor rollers 51 provide a good support for the entire area of a lower surface of the two-directionally bent glass sheet 10 and the upper quench conveyor rollers 52 provide a good support for the entire area of an upper surface of the two-directionally bent glass sheet 10, because the upper and lower quench conveyor rollers 53 and 52 have a curved shape and are arranged to form an arcuate shape in the direction of conveyance.

By thus properly supporting the two-directionally bent glass, the two-directionally bent glass sheet 10 can be cooled while maintaining a desired curved shape or configuration. This ensures production of a two-directionally bent glass sheet 10 with high accuracy.

Furthermore, according to the cooling mechanism 50, it is possible to alter the curved shape of the two-directionally bent glass sheet in the direction perpendicular to the conveyance direction as desired by altering or changing the curved shape of the upper and lower quench conveyor rollers 51 and 52 appropriately by adjusting the handles 64a and nuts 64b of the curve-and-support members 64 and 74 as described before.

The construction of the lower or upper quench conveyor rollers 51 or 52 as described with reference to FIG. 6 is not limitative, but may include such a modification that the rod 51a or 52a is stationary while the large-diameter rollers 51b or 52b are rotatable and driven in rotation by a rotating drive unit.

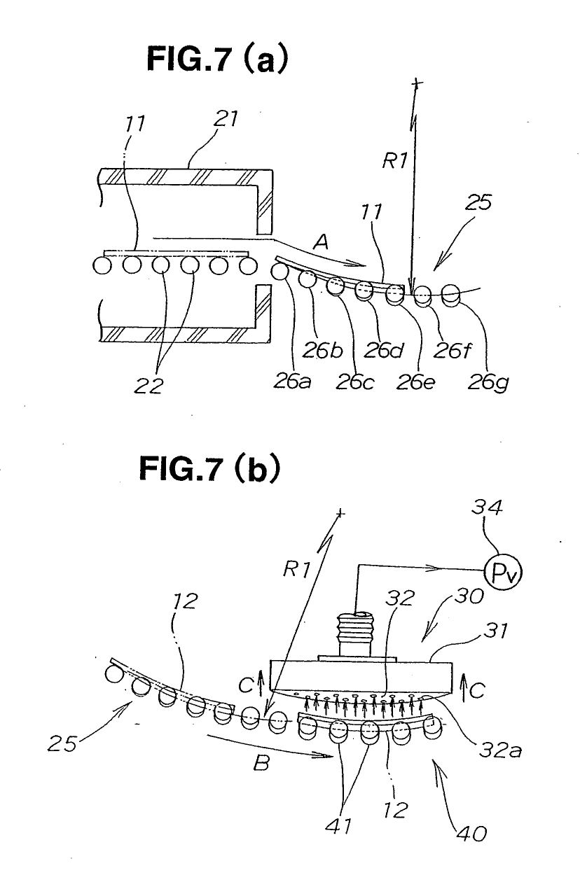

Description will now be made of operation of the bent glass sheet producing apparatus 10. FIGS. 7(a) and (b) diagrammatically illustrate a first stage of operation of the bent glass sheet producing apparatus according to the first embodiment.

As shown in FIG. 7(a), the glass sheet 11 in the heating furnace 21 is heated to near a softening temperature thereof as it is conveyed by the conveyor rollers 22. Then, the heated glass sheet 11 is transferred onto the first to seventh preliminary forming rollers 26a to 26g of the preliminary forming mechanism 25, as indicated by the arrow A shown in FIG. 7(a).

The first to seventh preliminary forming rollers 26a to 26g of the preliminary forming mechanism 25 are arranged at given intervals in the conveyance direction on an are of radius R1 the preliminary forming rollers 26b-26g have different curvatures that become gradually greater in a direction from the upstream end to the downstream end of the preliminary forming zone Z2 (FIG. 2).

Thus, the first to seventh preliminary forming rollers 26a-26g allow the glass sheet 11 to undergo preliminary bending caused by sagging in two directions, i.e. the direction of its conveyance and the direction perpendicular to the conveyance direction while the glass sheet 11 is conveyed by the preliminary forming rollers 26a-26g, as shown by the arrow A.

The drawing shows the curvature of radius R1 in an exaggerated way, and the real radius is large enough to ensure that the glass sheet 11 not bend in an upwardly convex form at the exit of the heating furnace 21.

Referring to FIG. 7(b), the glass sheet 12 formed preliminarily in the two directions by the preliminary forming mechanism 25 is conveyed to the conveyor roller mechanism 40 as shown by an arrow B, so that the glass sheet 12 may be conveyed to below the forming die 31 of the two-directional bending mechanism 30 by the conveyor rollers 41 of the conveyor roller mechanism 40.

When the glass sheet 12 has been conveyed to below the forming die 31 of the two-directional bending mechanism 30, the vacuum pump 34 is driven to draw air into the forming die 31 through the suction holes 32a to thereby draw the glass sheet 12 into intimate contact with the forming surface 32, by suction as shown by an arrow C.

In this instance, if air is blown up from below the glass sheet 12, lifting by suction of the glass sheet 12 will occur efficiently. This will ensure dose fitting of the glass sheet 12 over the forming surface 32 of the forming die 31.

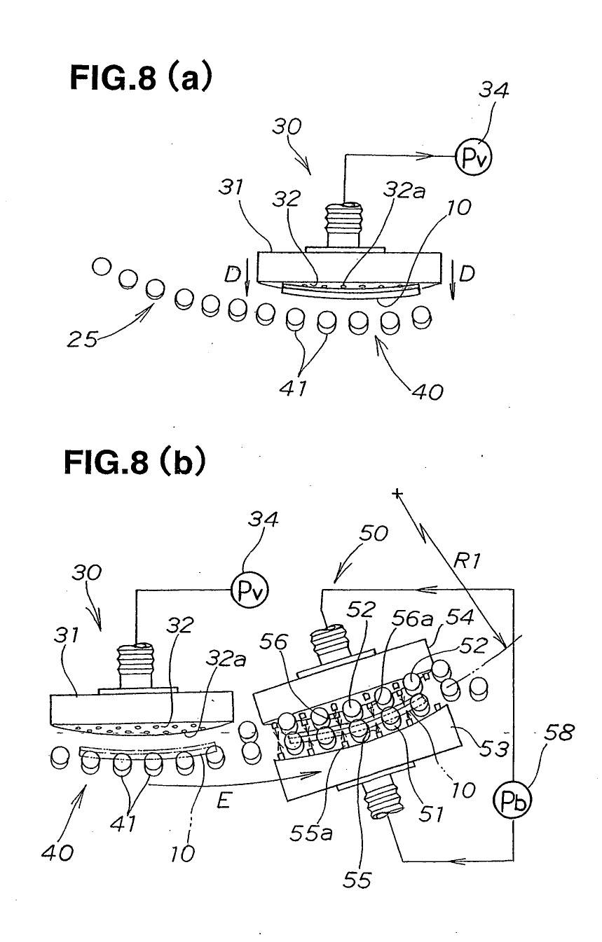

FIGS. 8(a) and 8(b) diagrammatically illustrate a second stage of operation of the bent glass sheet producing apparatus according to the first embodiment.

As shown in FIG. 8(a), the glass sheet 12 (see FIG. 7(b)) is brought into intimate contact with the forming surface 32 of the forming die 31, and by thus contacting the glass sheet against the forming surface 32, the glass sheet 12 (FIG. 7(b)) is bent into a two-directionally bent glass sheet 10 that has, on one hand, an arcuate shape having an equal radius R1 of curvature at any point thereof in the conveyance direction and, on the other hand, an arcuate shape having an equal radius R2 at any point thereof in the direction perpendicular to the conveyance direction.

Thus, the glass sheet 10 is bent in two mutually perpendicular directions with given curvatures.

After the two-directionally bent glass sheet 10 has been formed, operation of the vacuum pump 34 is stopped whereupon the two-directionally bent glass sheet 10 adhering closely by suction to the forming surface 32 is allowed to fall down onto the conveyor rollers 41 of the conveyor roller mechanism 40, as indicated by the arrow D shown in FIG. 8(a).

As shown in FIG. 8(b), the two-directionally bent glass sheet 10 which has been transferred to the conveyor rollers 41 of the conveyor roller mechanism 40 is conveyed to the cooling mechanism 50, as indicated by the arrow E.

The conveyor rollers 41 of the conveyor roller mechanism 40 that have an arcuate shape of radius R2 as viewed in the direction perpendicular to the conveyance direction and are arranged on an are having a radius R1 as viewed in the direction of conveyance provide a good support for the entire area of a lower surface of the two-directionally bent glass sheet 10.

This ensures that the two-directionally bent glass sheet 10 is conveyed to the cooling mechanism 50 while maintaining a desired curved configuration.

In the cooling mechanism 50, the air supply pump 58 is driven so that streams of pressurized air ejected from the nozzles 55a, 56a (forming the air jetting surfaces 55, 56, respectively) are blown against both the lower and upper surfaces of the two-directionally bent glass sheet 12.

According to the cooling mechanism 50, the lower quench conveyor rollers 51 provide a good support for the entire area of the lower surface of the two-directionally bent glass sheet 10 and the upper quench conveyor rollers 52 provide a good support for the entire area of the upper surface of the two-directionally bent glass sheet 10, because the upper and lower quench conveyor rollers 52 and 51 have a curved shape and are arranged to form an arcuate shape in the conveyance direction.

By thus blowing air against both the upper and lower surface of the two-directionally bent glass sheet 10 while maintaining a desired curved configuration, it is possible to forcibly cool or quench the two-directionally bent glass sheet 10 to temper the same.

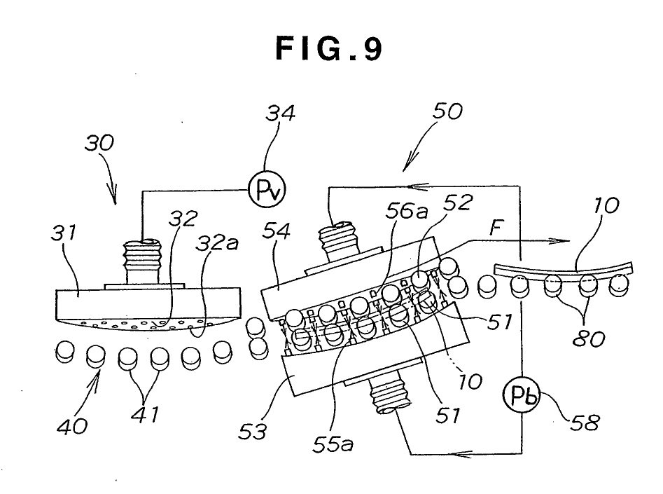

FIG. 9 diagrammatically illustrates a third stage of operation of the bent glass sheet producing apparatus according to the first embodiment.

The two-directionally bent glass sheet 10 which has been cooled by the cooling mechanism 50 is transferred from the upper and lower quench conveyor rollers 52, 51 to the conveyor rollers 80, as indicated by the arrow F shown in FIG. 9. The glass sheet 10 is then conveyed by the conveyor rollers 80 to any desired place for example, an inspection area). This completes a process for the production of the two-directionally bent glass sheet 10.

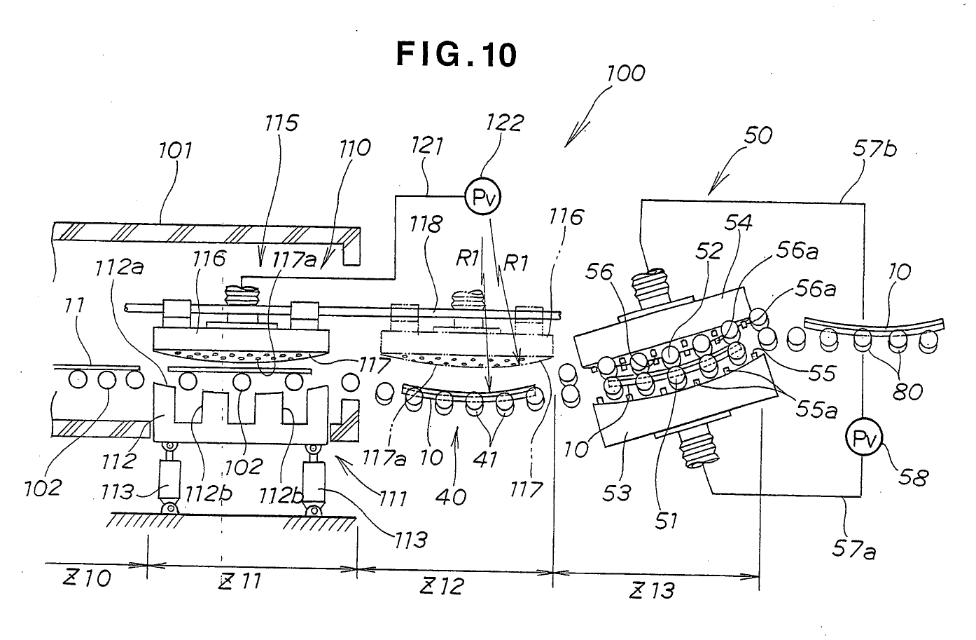

Description will now be made of apparatus for producing a bent glass sheet according to a second and a third embodiment with reference to FIGS. 10 to 19. The reference numerals used for the first embodiment are used to denote like parts or members for the second and third embodiments, and no description thereof will be made.

FIG. 10 is a side elevational view showing a bent glass sheet producing apparatus according to a second embodiment of the present invention.

The apparatus 100 generally comprises a heating furnace 101 in a heating zone Z10, a two-directional bending mechanism 110 in a forming zone Z11 downstream of the heating zone Z10, a conveyor roller mechanism 40 in a conveying zone Z12 downstream of the forming zone Z11, and a cooling mechanism 50 in a cooling zone Z13 downstream of the conveying zone Z12.

The heating furnace 101 has a conveyor roller 102 for conveying the glass sheet 11 in the furnace 101 horizontally and adapted to heat the glass sheet 11 to near a softening temperature thereof.

The two-directional bending mechanism 110 is arranged such that the glass sheet 11 heated to near its softening temperature by the heating furnace 101 is lifted up by a lift means 111 and drawn by suction into intimate contact with a forming die 116 of a forming-and-transfer means 115 until the glass sheet 11 is bent into an arcuate shape having an equal radius R1 of curvature at any point thereof in the direction of conveyance and also into a curved shape which is equally downward convex at any point thereof in a direction perpendicular to the conveyance direction, thus forming a two-directionally bent glass sheet 10.

The two-directional bending mechanism 110 is further arranged such that the forming die 116 having the glass sheet 11 drawn by suction into intimate contact with the forming surface is moved to the conveying zone Z12 to transfer the two-directionally bent glass sheet 10 to the conveyor roller mechanism 40.

The conveyor roller mechanism 40 is identical with the mechanism used in the first embodiment described above and has a plurality of conveyor rollers 41 bent or cured to have an arcuate shape of radius R2 as viewed in the direction perpendicular to the direction of conveyance and arranged on and along an are of radius R1 as viewed in the direction of conveyance, in order to convey the two-directionally bent glass sheet 10 bent in the two directions by the two-directional bending mechanism 110.

The cooling mechanism 50 has the same structure as the mechanism used in the first embodiment described above and operates to cool the two-directionally bent glass sheet 10 conveyed by the conveyor roller mechanism 40. The cooling mechanism 50 is followed downstream by conveyor rollers 80 for conveying the two-directionally bent glass sheet 10 in a downstream direction after the glass sheet 10 is cooled by the cooling mechanism 50.

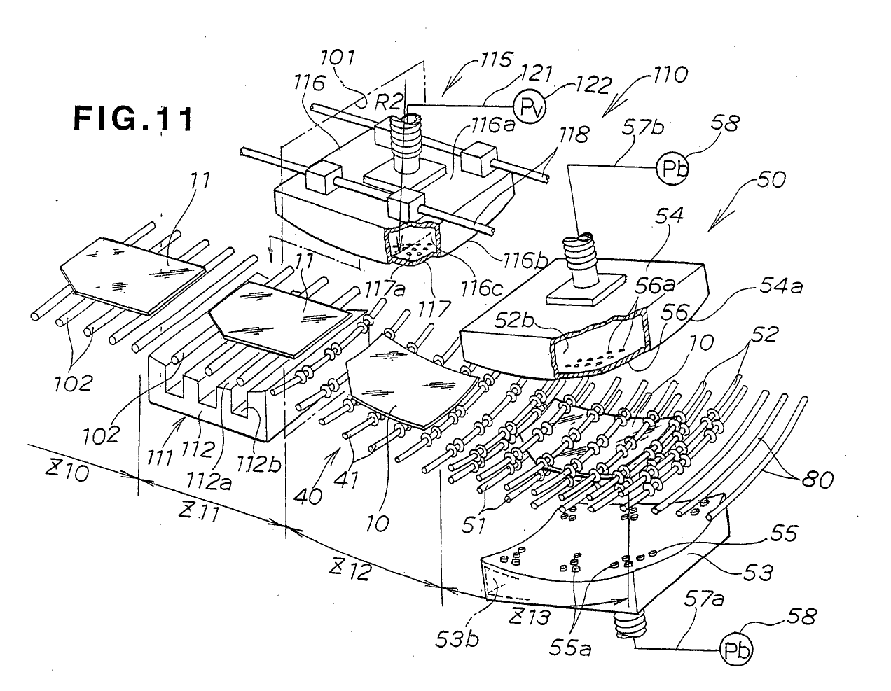

FIG. 11 is a perspective view of the bent glass sheet producing apparatus according to the second embodiment of the present invention.

The lift means 111 of the two-directional bending mechanism 110 includes a lift block 112 supported by lift cylinders 113 (FIG. 10) and adapted to move upward when piston rods of the lift cylinders 113 move forward.

By thus moving the lift block 112 upward, a top surface 112a of the lift block 112 protrude upwardly through gaps defined between the adjacent conveyor rollers 102 so that the thus protruding top surface 112a may carry the glass sheet 11 and force the same against the forming surface 117 of the forming die 116.

The lift block 112 has a plurality of parallel spaced transverse recessed portions or groove 12b formed in the top surface 112a to avoid interference with the conveyor rollers 102 when the lift block 112 is raised.

The forming-and-transfer means 115 of the two-directional bending mechanism 110 has a forming die 116 having a hollow structure and movable along guide rails 118 from the heating furnace 101 to the conveying zone Z12. The hollow forming die 116 has a top wall 116a connected via a suction passage 121 to a vacuum pump 122.

The hollow forming die 116 has a bottom wall 116b, and the forming surface 117 is formed on an exterior side of the bottom wall 116b. The forming surface 117 constitutes a two-directional bending surface having an arcuate shape with an equal radius of curvature at any point in the conveyance direction and a curved shape which is equally downward convex at any point in a direction perpendicular to the conveyance direction. The bottom wall 116b including the forming surface 117 has a plurality of suction holes 117a.

In the second embodiment, a relationship expressed as R1>R2 is also established as is the case of the first embodiment, where R1 (FIG. 10) is the radius of a curvature of the arcuate shape of the forming surface 117 in the conveyance direction and R2 is the radius of an are of the downward convex curved shape of the forming surface 117 in the direction perpendicular to the conveyance direction.

The top surface 112a of the lifting block 0.112 is formed to have a concave are of radius R1 in the conveyance direction and a concave are of radius R2 in a direction perpendicular to the conveyance direction so as to conform to the forming surface 117 of the forming die 116.

With this arrangement, the suction holes 17a is connected with the vacuum pump 122 through the hollow interior 116c of the forming die 116 and the suction passage 121. Thus, when the vacuum pump 122 is driven to draw air from the suction holes 117a into the hollow interior 116c of the forming die 116, the glass sheet 11 while being lifted up an elevated position by the lift block 112 can be attracted by suction against the forming surface 117 of the forming die 116 and comes into intimate contact with the forming surface 117.

The glass sheet 11 heated to near its softening temperature, as it is attracted by suction against the forming surface 117 of the forming die 116, is bent or shaped into a two-directionally bent glass sheet 10 having an arcuate shape with an equal radius R1 of curvature at any point thereof in the conveyance direction and also an arcuate shape with an equal radius R2 at any point thereof in a direction perpendicular to the conveyance direction.

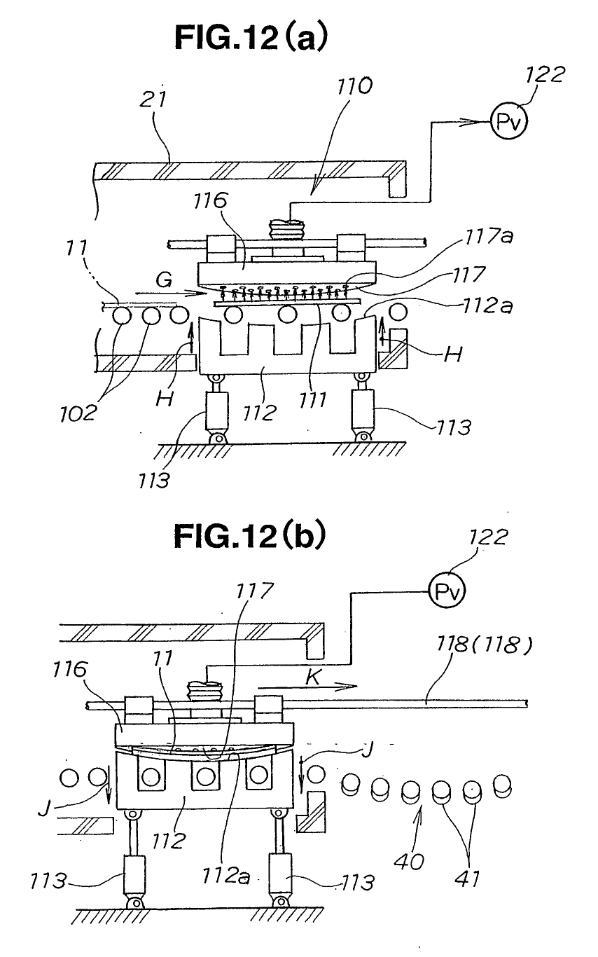

Description will now be made of operation of the bent glass sheet producing apparatus 100 according to the second embodiment. FIGS. 12(a) and 12(b) diagrammatically show a first stage of operation of the apparatus 100.

As shown in FIG. 12(a), the glass sheet 11 in the heating furnace 101 is heated to near its softening temperature, while the glass sheet 11 is conveyed downstream by the conveyor rollers 102. Then, the heated glass sheet 11 is further conveyed downstream to the two-directional bending mechanism 110, as indicated by the arrow G.

When the glass sheet 11 has been conveyed to the two-directional bending mechanism 110, the vacuum pump 122 is driven to draw air into the forming die 116 through the plural suction holes 117a, and the piston rods of the lift cylinders 113 are advanced or extended to raise the lift block 112 as indicated by the arrows H.

As shown in FIG. 12(b), advancing movement of the piston rods causes the top surface 112a of the lift block 112 to protrude upwardly through the gaps between the conveyor rollers 102 to carry the heated glass sheet 11 thereon and then forces the glass sheet against the forming surface 117 of the forming die 116. At the same time, the glass sheet 11 thus forced against the forming surface 117 is attracted by suction against the forming surface 117 and held in intimate contact with the forming surface 117.

By virtue of intimate contact with the forming surface 117 of the forming die 116 by suction, the heated glass sheet 11 is formed into an arcuate shape having an equal radius R1 of curvature at any point thereof in the conveyance direction and also an arcuate shape having an equal radius R2 at any point thereof in a direction perpendicular to the conveyance direction. Thus, the glass sheet 11 is bent in two directions, and a two-directionally bent glass sheet 10 is obtained.

After the glass sheet 11 has been drawn into intimate contact with the forming surface 117, the piston rods of the lift cylinders 113 are retracted to lower the lift block 112, as indicated by the arrow J shown in FIG. 12(b).

Then, the forming die 116 is moved along the guide rails 118, as indicated by the arrow K.

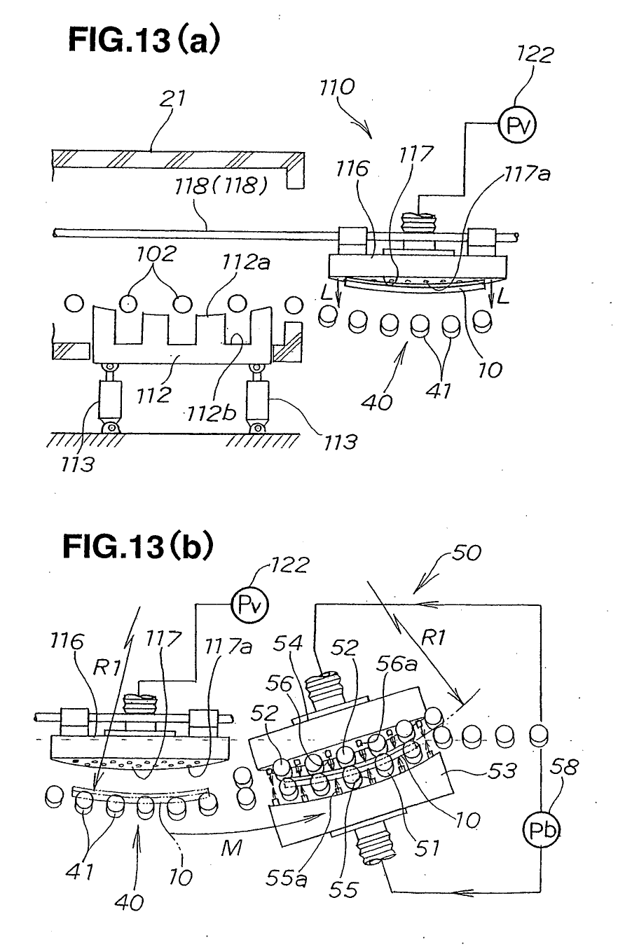

FIGS. 13(a) and 13(b) diagrammatically illustrate a second stage of operation of the bent glass sheet producing apparatus according to the second embodiment.

As shown in FIG. 13(a), after the forming die 116 has been moved to above the conveyor roller mechanism 40, operation of the vacuum pump 122 is stopped whereupon the two-directionally bent glass sheet 10 adhering closely to the forming surface 117 by suction is allowed to fall down onto the conveyor rollers 41 of the conveyor roller mechanism 40, as indicated by the arrows L.

The two-directionally bent glass sheet 10 which has been transferred to the conveyor rollers 41 of the conveyor roller mechanism 40 is conveyed to the cooling mechanism 50, as indicated by the arrow M shown in FIG. 13(b).

In this instance, since the conveyor rollers 41 of the conveyor roller mechanism 40 are curved in the direction perpendicular to the conveyance direction and also arranged to assume an arcuate shape as viewed in the conveyance direction, the conveyor rollers 41 provide a good support for the entire area of a lower surface of the two-directionally bent glass sheet 10.

This ensures reliable conveyance of the two-directionally bent glass sheet 10 to the cooling mechanism 50 while maintaining a given curved shape or configuration of the glass sheet 10.

In the cooling mechanism 50, the air supply pump 58 is driven so that the nozzles 55a and 56a forming the air jetting surfaces 55 and 56 eject streams of air against both the upper and lower surfaces of the two-directionally bent glass sheet 10.

In this instance, since the upper and lower quench conveyor rollers 51 and 52 of the cooling mechanism 50 are curved in the axial direction and arranged to assume an arcuate shape in the conveyance direction, the quench conveyor rollers 51, 52 provide a good for the entire area of upper and lower surfaces, respectively, of the two-directionally bent glass sheet 10.

This makes it possible to forcibly cool or quench the two-directionally bent glass sheet 10 for tempering the same by blowing air against the upper and lower surfaces of the glass sheet while maintaining a given curved shape or configuration of the glass sheet 10.

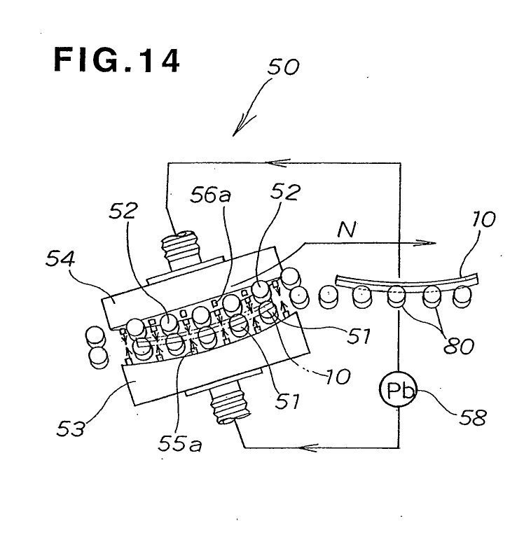

FIG. 14 diagrammatically illustrates a third stage of operation of the bent glass sheet producing apparatus according to the second embodiment.

The two-directionally bent glass sheet 10 which has been cooled by the cooling mechanism 50 is transferred by the upper and lower quench conveyor rollers 52 and 51 to the conveyor rollers 80, as indicated by the arrow N, and is thereafter conveyed by the conveyor rollers 80 to any desired place (for example, an inspection area). Process for the production of the two-directionally bent glass sheet 10 is thus completed.

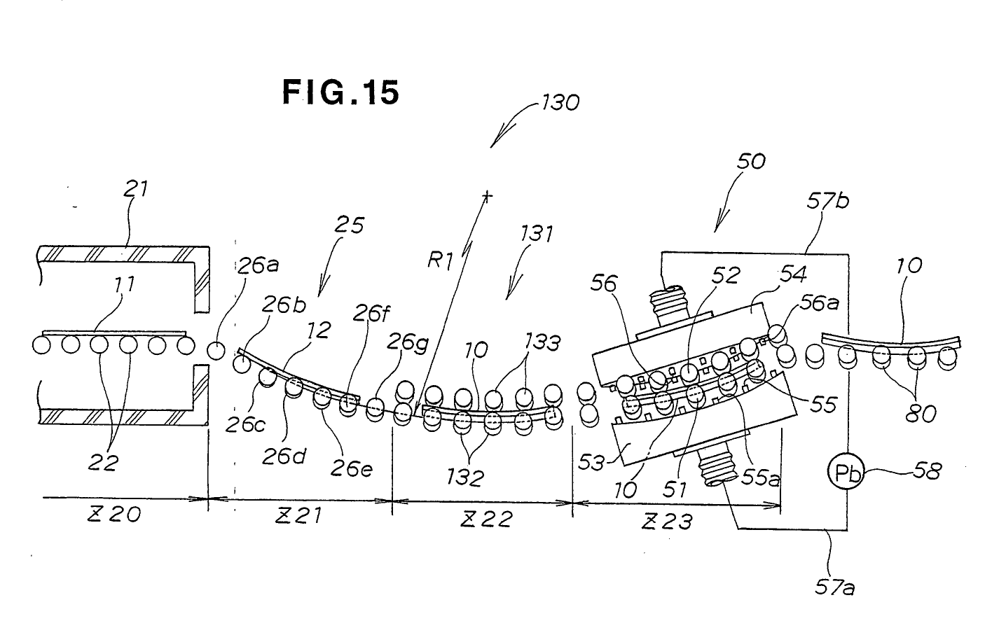

FIG. 15 shows in side view a bent glass sheet producing apparatus according to a third embodiment of the present invention.

The bent glass sheet producing 130 has a heating furnace 21 in a heating zone Z20, a preliminary forming mechanism 25 in a preliminary forming zone Z21 downstream of the heating zone Z20, a two-directional bending mechanism 131 in a forming zone Z22 downstream of the preliminary forming zone Z21 and a cooling mechanism 50 in a cooling zone Z23 downstream of the forming zone Z22.

The two-directional bending mechanism 131 is arranged to shape a preliminary two-directionally bent glass sheet 12 into a final two-directionally bent glass sheet 10 as the preliminary two-directionally bent glass sheet 12 is conveyed while being gripped by and between a plurality of lower forming rollers 132 and a plurality of upper forming rollers 133. By the two-directional bending mechanism 131, the preliminary two-directionally bent glass sheet 12 is bent into an arcuate shape having an equal radius R1 of curvature at any point thereof in the conveyance direction and also into a curved shape which is equally downward convex at any point thereof in a direction perpendicular to the conveyance direction.

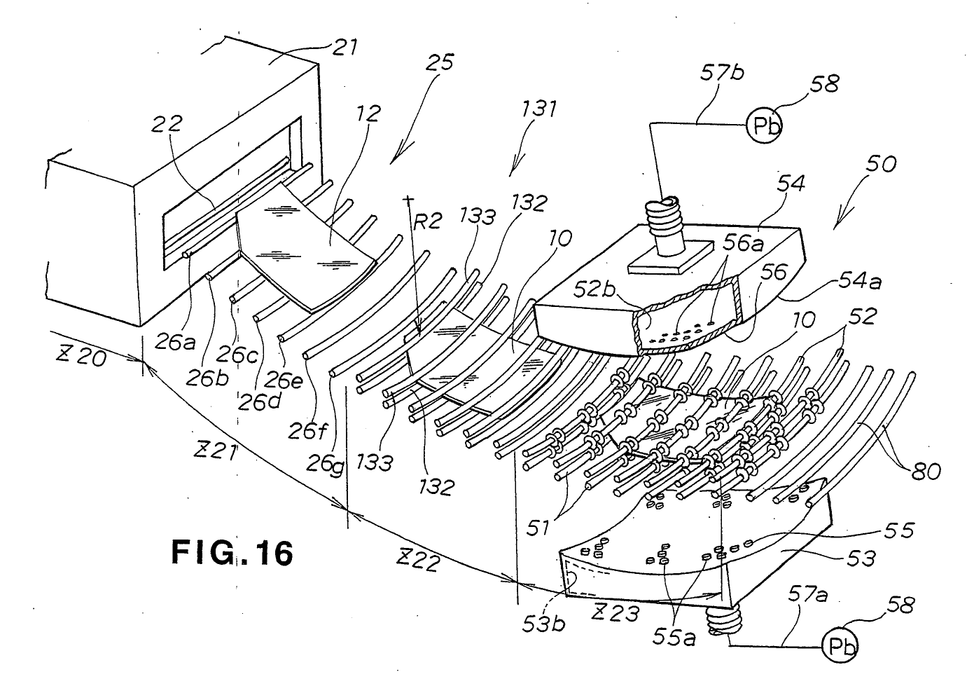

FIG. 16 is a perspective view showing the bent glass sheet producing apparatus according to the third embodiment of this invention.

The two-directional bending mechanism 131 has upper and lower forming rollers 132 and 133 that are arranged to assume a downwardly convex arcuate shape of radius R1 in the conveyance direction and have a downward convex curved shape in the axial direction of the forming rollers 132, 133.

According to the present embodiment, the downward convex curved shape is an are of radius R2 and the relationship between radiuses R1 and R2 is expressed as R1>R2, in the same manner as the first and second embodiments previously discussed.

With the two-directional bending mechanism 131 thus arranged, the glass sheet 12, as it is conveyed while being held between the upper and lower forming rollers 132, 133, is bent to have an arcuate shape with an equal radius R1 at any point thereof in the conveyance direction and also an arcuate shape having an equal radius R2 at any point thereof in a direction perpendicular to the conveyance direction. By thus bending the glass sheet 12, a two-directionally bent glass sheet 10 is obtained.

Furthermore, the lower forming rollers 132 of the two-directional bending mechanism 131 provide a good support for the entire area of a lower surface of the two-directionally bent glass sheet 10 and the upper forming rollers 133 provide a good support for the entire area of an upper surface of the same glass sheet 10. This ensures that the two-directionally bent sheet 10 is conveyed reliably while maintaining a given bent shape or configuration, which leads to production of such two-directionally bent glass sheet with improved accuracy.

Additionally, since the upper and lower forming rollers 132, 133 are arranged to assume an arcuate shape of radius R1 in the conveyance direction and each have an arcuate shape of radius R2 in the axial direction, and since a relationship expressed as R1>R2 is established, it is possible to provide conveying surfaces that are relatively mildly curved in the direction of conveyance. This ensures smooth conveyance of the two-directionally bent glass sheet 10, which leads to proper bending of the glass sheet.

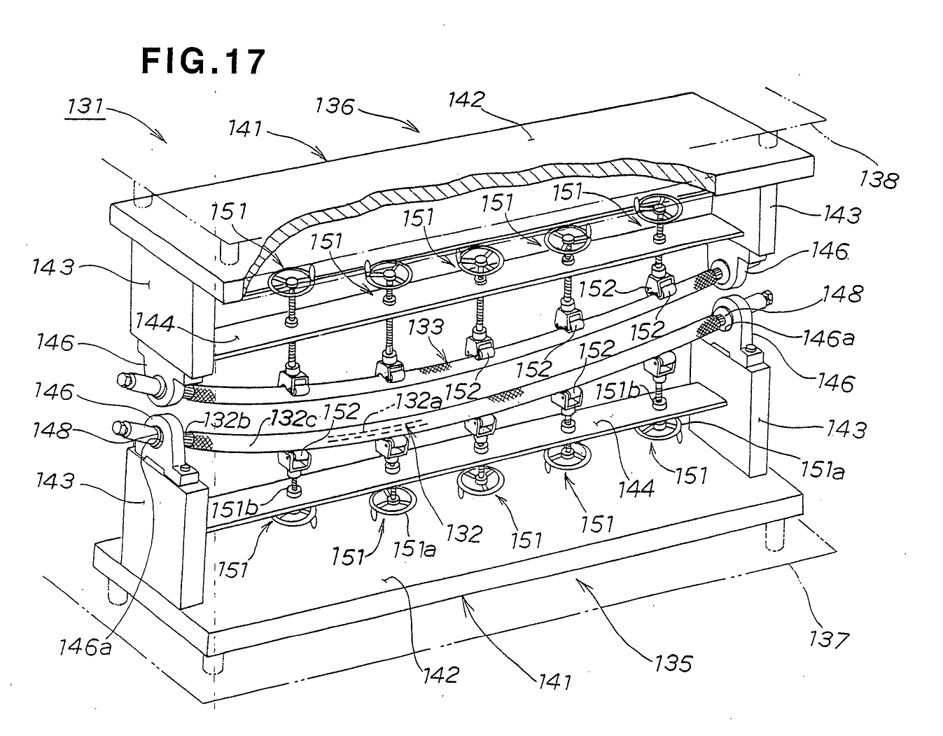

FIG. 17 is a perspective view showing the two-directional bending mechanism of the bent glass sheet producing apparatus according to the third embodiment.

The two-directional bending mechanism 131 is composed of a lower forming roller unit 135 having a lower forming roller 132, an upper forming roller unit 136 having an upper forming roller 133, a lower frame 137 for connecting a plurality of lower forming roller units 135 and an upper frame 138 for connecting a plurality of upper forming roller units 136.

Each lower forming roller unit 135 has right and left support members 146 disposed on a base 141 and rotatably and tiltably supporting opposite end portions of the lower forming roller 132, and a plurality of backup members 151 for supporting the lower forming roller 132 in a concavely curved shape or configuration.

The base 141 is composed of a base table 142, support blocks 143 attached to right and left ends of the base table 142, and a cross member 144 extending between the support blocks 143.

The support members 146 are attached to the support blocks 143 and have mounting holes 146a in which bushes 148 are fitted for both rotational movement and swivel movement relative to the support members 146.

The lower forming roller 132 is composed of an elastic roller shaft 132a, an elastic circumferential material 132b disposed on the surface of the roller shaft along its axis, and a coil spring 132c for bundling the circumferential material 132b together with the roller shaft 132a.

The right and left end portions of the lower forming roller 132 are fitted in the bushes 148, and predetermined longitudinal portions of the lower forming roller 132 are supported the respective backup members 151 in such a manner that the lower forming roller 132 assumes a given concavely curved configuration.

Each backup member 151 has a pair of backup rollers 152 held in contact with the surface of the lower forming roller 132, and a handle 151a and a nut 151b that are provided to adjust the vertical position or height of a corresponding one of the pair of backup rollers 152 so as to realize the given curved configuration of the lower forming roller 132. The curved configuration of the lower forming roller 132 may be an upwardly concave arcuate shape of radius R2.

The upper forming roller unit 136 has the same construction as the lower forming roller unit 135. Thus, the upper forming roller unit 136 has right and left support members 146 disposed on a base 141 and rotatably and tiltably supporting opposite end portions of the upper forming roller 133, and a plurality of backup members 151 for supporting the upper forming roller 132 in a downwardly convex curved shape or configuration.

By properly adjusting a handle 151a and a nut 151b of each backup member 151, the upper forming roller 133 can be bent into a desired curved configuration such as a downwardly convex arcuate shape of radius R2.

According to the two-directionally bending mechanism 131, the arcuate shape with radius R2 of the upper and lower forming rollers 133, 132 can be changed to any desired curved configuration by properly adjusting the handles 151a and nuts 151b of the upper and lower backup members 151. This means that the arcuate shape with radius R2 in a direction perpendicular to the conveyance direction of the glass sheet can be changed into any desired curved shaped or configuration.

The structure of the lower and upper forming rollers 132, 133 as described with reference to FIG. 17 is not restrictive. For example, each forming roller may include a sleeve fitted over a roller shaft and adapted to be rotated, as in the same manner as the first to seventh preliminary forming rollers 26a to 26g used in the preliminary forming mechanism 25 of the first embodiment.

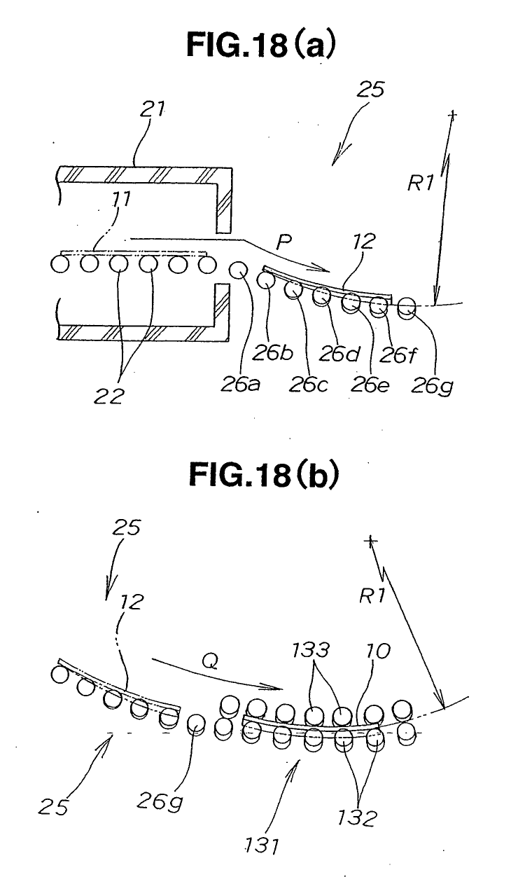

Description will now be made of the operation of the bent glass sheet producing apparatus 130 according to the third embodiment of the present invention. FIGS. 18(a) and 18(b) diagrammatically show a first stage of operation of the bent glass sheet producing apparatus.

As shown in FIG. 18(a), the glass sheet 11 in the heating furnace 21 is heated to near its softening temperature, while it is conveyed by the conveyor rollers 22. Then, the glass sheet 11 heated to near its softening temperature is conveyed onto the first to seventh preliminary forming rollers 26a to 26g of the preliminary forming mechanism 25, as indicated by the arrow P.

The preliminary forming mechanism 25 allows the glass sheet 11 to bend preliminarily by sagging in two directions, i.e. a direction of conveyance and a direction perpendicular to the conveyance direction, during conveyance of the glass sheet 11, as in the case of the first embodiment.

Although the drawing shows the curvature of radius R1 in an exaggerated way, the real radius is large enough to ensure that the glass sheet 11 not bend in an upwardly convex format the exit of the heating furnace 21.

As shown in FIG. 18(b), the glass sheet 12 formed in two directions preliminarily by the preliminary forming mechanism 25 is transferred to the two-directional bending mechanism 131 as indicated by the arrow Q. The glass sheet 12 transferred to the two-directional bending mechanism 131 is conveyed while being held or gripped by and between the upper and lower forming rollers 133 and 132 of the two-directional bending mechanism 131.

By virtue of this conveyance, the glass sheet 12 is formed or shaped to have both an arcuate shape of an equal radius R1 at any point thereof in the direction of conveyance and an arcuate shape having an equal radius R2 at any point thereof in a direction perpendicular to the conveyance direction. The glass sheet 12 is thus bent in two mutually perpendicular directions.

As the glass sheet 12 can be bent in two directions, i.e. the direction of its conveyance and the direction perpendicular to the conveyance direction, while the glass sheet is conveyed by the upper and lower forming rollers 133, 132, it is possible to secure reliable conveyance of the two-directionally bent glass sheet 10, while maintaining a given curved shape or configuration of the glass sheet.

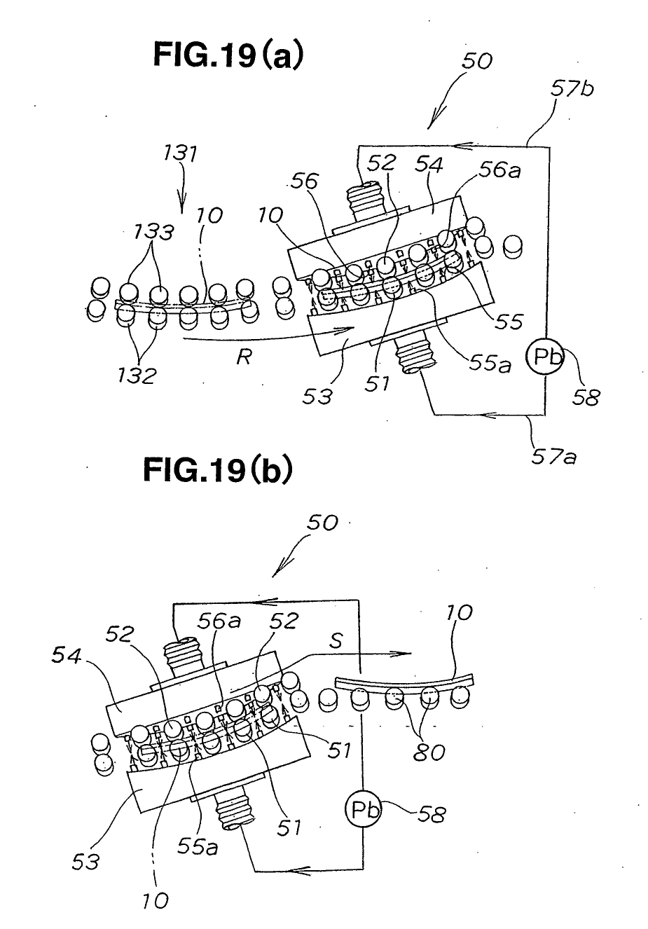

FIGS. 19(a) and 19(b) diagrammatically illustrate a second stage of operation of the bent glass sheet producing apparatus according to the third embodiment.

As shown in FIG. 19(a), the two-directionally bent glass sheet 10 formed by the two-directional bending mechanism 131 is conveyed to the cooling mechanism 50 as indicated by the arrow R.

By thus conveying the two-directionally bent glass sheet 10 to the cooling mechanism 50, it is possible to forcibly cool or quench the two-directionally bent glass sheet 10 for tempering the same by blowing air against upper and lower surfaces of the glass sheet 10 while maintaining a given-curved shape or configuration of the glass sheet 10.

As shown in FIG. 19(b), the two-directionally bent glass sheet 10 which has been cooled by the cooling mechanism 50 is transferred by the upper and lower quench conveyor rollers 52 and 51 to the conveyor rollers 80, as indicated by the arrow S. The bent glass sheet 10 is thereafter conveyed by the conveyor rollers 80 to any desired place (for example, an inspection area). This process completes the production of the two-directionally bent glass sheet 10.

Although in the first and second embodiments, the curvatures of the forming surfaces 32 and 117 of the forming dies 31 and 116, respectively, are set to be equal to the radiuses R1 and R2 regardless of the thickness of the glass sheet, it is also possible to employ smaller radiuses than R1 and R2 for the curvature of the forming surfaces 32 and 117 by taking the thickness of the glass sheet into account.

Although the upper forming rollers 133 in the third embodiment are arranged on a curved line of radius R1 and bent with radius R2 regardless of the thickness of the glass sheet, it is also possible to make smaller the radiuses R1 and R2 of the upper forming rollers 133 by taking the thickness of the glass sheet into account.

Moreover, in the first to third embodiments, the cooling mechanism 50 is arranged to blow air against the two-directionally bent glass sheet 10 so as to forcibly cool or quench the glass sheet 10. Such a forcible cooling or quenching is not restrictive but the invention may include gradual cooling of the bent glass sheet 10 which may be achieved by blowing air weakly against the two-directionally bent glass sheet.

Furthermore, in the first to third embodiments, the two-directionally bent glass sheet 10 is shaped with an equal radius R1 of curvature in the direction of conveyance and an equal radius R2 of curvature in a direction perpendicular to the conveyance direction wherein R1>R2. The relationship between R1 and R2 is not limited to the one (R1>R2) shown in the illustrated embodiments.

Moreover, while the first to third embodiments have been described in conjunction with two-directional bending of a glass sheet in which the curvature of the downward convex curved shape of the two-directionally bent glass sheet 10 in the direction perpendicular to the conveyance direction is an are of radius R2, bending in the direction perpendicular to the conveyance direction is not limited to those achieved to realize an arcuate shape but may a downward convex curved shape may suffice the curvature of the two-directionally bent glass sheet in the same direction.

Furthermore, in the first and second embodiments, the glass sheet 11 is drawn by suction into intimate contact with the forming surfaces 32 and 117 of the forming dies 31 and 116, respectively. It is also possible to employ a different method for the purpose of achieving intimate contact between the glass sheet 11 and the forming surface 32 or 117.

### INDUSTRIAL APPLICABILITY

With the arrangements so far described, the present invention can be used advantageously as an apparatus for and a method of producing a two-directionally bent glass sheet with high efficiency and improved accuracy and hence is useful in the manufacture of lass sheet.

1. An apparatus for producing a bent glass sheet, comprising:
a heating furnace capable of heating a glass sheet to near a softening temperature of the glass sheet;
a two-directional bending mechanism for bending the heated glass sheet in two directions by bringing the heated glass sheet into contact with a forming surface of a forming die to thereby form the heated glass sheet into an arcuate shape having an equal radius of curvature at any point of the glass sheet in a direction of conveyance of the glass sheet, while forming the heated glass sheet into a curved shape which is equally downward convex in a direction perpendicular to the conveyance direction;
a conveyor roller mechanism for conveying the two-directionally bent glass sheet and including a plurality of conveyor rollers having conveying surfaces complementary in shape to the downward convex curved shape of the two-directionally bent glass sheet and arranged on an arcuate line having the same radius of curvature as the arcuate shape of the two-directionally bent glass sheet; and
a cooling mechanism for cooling the two-directionally bent glass sheet while the two-directionally bent glass sheet is conveyed by the conveyor roller mechanism.

2. The apparatus according to claim 1, further including a preliminary forming mechanism having curved rollers for conveying the heated glass sheet from the heating furnace to the two-directional bending mechanism and allowing the heated glass sheet to bend preliminarily by sagging during conveyance by the curved rollers.

3. The apparatus according to claim 1, wherein the two-directional bending mechanism is arranged to satisfy a relationship R1>R2 where R1 is the radius of the arcuate shape of the two-directionally bent glass sheet in said conveyance direction of the glass sheet, and R2 is the radius of an are defined by the curved shape of the two-directionally bent glass sheet in said direction perpendicular to the conveyance direction.

4. An apparatus for producing a bent glass sheet, comprising:
a heating furnace capable of heating a glass sheet to near a softening temperature of the glass sheet;
a preliminary forming mechanism including curved rollers for allowing the heated glass sheet to bend preliminarily by sagging while the heated glass sheet is conveyed by the curved rollers;
a two-directional bending mechanism for bending the preliminarily bent glass sheet in two directions by conveying the preliminarily bent glass sheet while holding the same between a plurality of lower forming rollers and a plurality of upper forming rollers to thereby form the preliminary bent glass sheet into an arcuate shape having an equal radius of curvature at any point of the glass sheet in a direction of its conveyance, while forming the preliminarily bent glass sheet into a curved shape which is downward convex in a direction perpendicular to the conveyance direction; and
a cooling mechanism for cooling the two-directionally bent glass sheet.

5. The apparatus according to claim 4, wherein the upper forming rollers and the lower forming rollers are each have a curved shape same as the curved shape of the two-directionally bent glass sheet and arranged on an arcuate line having the same radius of curvature as the arcuate shape of the two-directionally bent glass sheet, and the two-directional bending mechanism is arranged to satisfy a relationship R1>R2 where R1 is the radius of the arcuate shape of the upper and lower forming rollers in said conveyance direction of the glass sheet, and R2 is the radius of an are defined by the curved shape of the upper and lower forming rollers in said direction perpendicular to the conveyance direction.

6. The apparatus according to claim 1, wherein the cooling mechanism includes a plurality of pairs of upper and lower cooling conveyor rollers for holding the two-directionally bent glass sheet therebetween, and the upper cooling conveyor rollers and the lower cooling conveyor rollers are each have a curved shape same as the curved shape of the two-directionally bent glass sheet and arranged on an arcuate line along the conveyance direction of the glass sheet, the arcuate line having the same radius of curvature as the arcuate shape of the two-directionally bent glass sheet.

7. The apparatus according to claim 6, further including upper and lower cooling nozzle boxes for blowing air against the two-directionally bent glass sheet to forcibly cool down the two-directionally bent glass sheet while the two-directionally bent glass sheet is conveyed by the upper and lower cooling conveyor rollers.

8. A method of producing a bent glass sheet, comprising the steps of:
heating a glass sheet to near its softening temperature in a heating furnace;
bending the heated glass sheet in two directions by bringing the heated glass sheet into contact with a forming surface of a forming die to thereby form the heated glass sheet into an arcuate shape having an equal radius of curvature at any point of the glass sheet in a direction of its conveyance, while forming the heated glass sheet into a curved shape which is downward convex in a direction perpendicular to the conveyance direction;
conveying the two-directionally bent glass sheet to a cooling mechanism while carrying the two-directionally bent glass sheet on conveyor rollers having conveying surfaces complementary in shape to the convex curved shape of the two-directionally bent glass sheet and arranged on an arcuate line having the same radius of curvature as the arcuate shape of the two-directionally bent glass sheet; and
quenching the two-directionally bent glass sheet by the cooling mechanism.

9. The method according to claim 8, further comprising, between the heating and the bending, preliminarily bending the heated glass sheet by conveying the heated glass sheet by curved rollers and allowing the heated glass sheet to bend by sagging during conveyance by the curved rollers.

10. The method according to claim 8, wherein the heated glass sheet is brought into contact with the forming surface of the forming die in such a manner as to satisfy a relationship R1>R2 where R1 is the radius of the arcuate shape of the two-directionally bent glass sheet in said conveyance direction of the glass sheet, and R2 is the radius of an are defined by the curved shape of the two-directionally bent glass sheet in said direction perpendicular to the conveyance direction.

11. A method of producing a bent glass sheet, comprising:
heating a glass sheet to near its softening temperature in a heating furnace;
conveying the heated glass sheet by curved rollers and allowing the heated glass to bend preliminarily by sagging during conveyance by the curved rollers;
bending the preliminarily bent glass sheet in two directions by conveying the preliminarily bent glass sheet to a cooling mechanism while supporting the preliminary bent glass sheet between a plurality of upper forming rollers and a plurality of lower forming rollers so as to form the preliminarily bent glass sheet into an arcuate shape having an equal radius of curvature at any point of the glass sheet in the direction of its conveyance, while forming the preliminarily bent glass sheet into a curved shape which is downward convex in a direction perpendicular to the conveyance direction; and
quenching the two-directionally bent glass sheet by the cooling mechanism.

12. The method according to claim 11, wherein the preliminarily bent glass sheet, as it is conveyed while being supported between the upper and lower forming rollers, is gradually bent in said two directions in such a manner as to satisfy a relationship R1>R2 where R1 is the radius of the arcuate shape of the two-directionally bent glass sheet in said conveyance direction of the glass sheet, and R2 is the radius of an are defined by the curved shape of the two-directionally bent glass sheet in said direction perpendicular to the conveyance direction.

13. The method according to claim 8 or 11, wherein while the two-dimensionally bent glass sheet is quenched by the cooling mechanism, the two-directionally bent glass sheet is conveyed while being supported by and between upper cooling conveyor rollers and lower cooling conveyor rollers, the upper and lower cooling conveyor rollers having a curved shape same as the curved shape of the two-directionally bent glass sheet in said direction perpendicular to the conveyance direction, the upper and lower cooling conveyor rollers being each arranged on an arcuate line extending along the conveyance direction, the arcuate line having the same radius of curvature as the arcuate shape of the two-directionally bent glass sheet.

14. The method according to claim 13, wherein said quenching is carried out by blowing air against both upper and lower surfaces of the two-directionally bent glass sheet while the two-directionally bent glass sheet is conveyed in a supported fashion by and between the upper and lower cooling conveyor rollers.

15. The apparatus according to claim 4, wherein the cooling mechanism includes a plurality of pairs of upper and lower cooling conveyor rollers for holding the two-directionally bent glass sheet therebetween, and the upper cooling conveyor rollers and the lower cooling conveyor rollers are each have a curved shape same as the curved shape of the two-directionally bent glass sheet and arranged on an arcuate line along the conveyance direction of the glass sheet, the arcuate line having the same radius of curvature as the arcuate shape of the two-directionally bent glass sheet.

16. The method according to claim 11, wherein while the two-dimensionally bent glass sheet is quenched by the cooling mechanism, the two-directionally bent glass sheet is conveyed while being supported by and between upper cooling conveyor rollers and lower cooling conveyor rollers, the upper and lower cooling conveyor rollers having a curved shape same as the curved shape of the two-directionally bent glass sheet in said direction perpendicular to the conveyance direction, the upper and lower cooling conveyor rollers being each arranged on an arcuate line extending along the conveyance direction, the arcuate line having the same radius of curvature as the arcuate shape of the two-directionally bent glass sheet.
